(19) United States
(12) Patent Application Publication
(10) Pub. No.: US 2014/0358974 A1
(43) Pub. Date: Dec. 4, 2014

(54) SYSTEM AND METHOD FOR INTEGRAL MANAGEMENT OF INFORMATION FOR END USERS

(71) Applicants: FLEXIBLE USER EXPERIENCE S.L., Amposta (Tarragona) (ES); UNIVERSITAT ROVIRA I VIRGILI, Tarragona (Tarragona) (ES)

(72) Inventors: Santiago Romaní Also, Tarragona (Tarragona) (ES); David Romaní Also, Amposta (Tarragona) (ES); Carlos García-Barroso Villalonga, Barcelona (Barcelona) (ES)

(21) Appl. No.: 13/908,988

(22) Filed: Jun. 3, 2013

(51) Int. Cl. G06F 17/30

(52) U.S. Cl. CPC G06F 17/30607
USPC 707/805; 707/803

(57) ABSTRACT

System and method for integrated management of end-user information. The system is composed of a unique computer application and a single object-oriented database. The unique computer application creates and edits objects of information of different types. The objects of information of different types are organized into hierarchical structures providing high-level structured documents recorded into the single object-oriented database. The objects of information of different types are identified by a type identifier and an object identifier. Each type of object of information is described in terms of data fields and metadata fields. The unique computer application is compound of a plurality of software components that can be included in or excluded from the application to provide specific functionality for implementing management of specific high-level structured documents.

### CROSS REFERENCE TO RELATED APPLICATIONS

This application claims priority rights of a pending Spanish application No P201230895) filed on Jun. 8, 2012, entitled “Aplicación de gestión Integral de información del usuario final” (Comprehensive management application of end-user information).

### TECHNICAL FIELD

This invention relates generally to computer systems running graphical programs and database software managers that allow an end user to handle a textual and multimedia information in a feasible manner and, more particularly, to object-based hierarchic information edition and management, context-sensitive user interfaces, and document-centered software.

In all this specification the term object of information or data object refers to an object containing only information of a specific or certain type. In turn, type of information or data type embrace in a non-limitative way: text, images, tables, plots, graphics, expressions, sounds, videos, e-mails, etc. Therefore an object of text type would mean an object where the information that contains is only in text format.

### BACKGROUND OF THE INVENTION

In the middle eighties, the introduction of graphical user interfaces and affordable computers lead to an extraordinary expansion of the usage of Computer Technology, which nowadays is involved in almost every human activity.

However, as the number of computer programs increases (as well as the number of their features and options), the end user is constantly impelled to an endless learning process. This press has been reinforced with the advent of new applications accessible through the Internet and mobile computing devices (smartphones, tablets, etc.). Arguably, current software is intended to be as easy to use as possible, and leading companies of the field invest lots of resources in this aim, but the fact that different tasks require different programs (or even different operating systems, browsers or computing devices) makes it considerably awkward for the user to concentrate on his/her job without putting significant efforts in learning the functionality of the programs.

Besides, doing the same task in different programs habitually require different procedures. For example, text edition is not handled equally in a word processor, in a spreadsheet application, in a presentation composer or in an e-mail manager, even in the case that all these programs are part of the same software package.

Moreover, inserting data generated with one program into another program can be arduous. Despite most programs recognize the typical <<copy & paste>> procedure, not all information contained in the original piece of data may be captured by the receiving program. For example, a graphic object edited by means of lines and curves in a 2D space will probably be converted into a pixel-based image when inserted in a text editing program. Even worse, when a small change have to be done to that graphic, one must open again the graphic with the original graphics editing program (if it was saved into its specific file) and repeat the copy and paste procedure to update the appearance of the image inserted in the text.

The aforementioned problems related to program interoperability were addressed in the early nineties by notable companies of the industry (e.g. Microsoft, IBM, Apple), which defined mechanisms to modularize the pieces of the programs that handled each kind of data, so as to invoke them when the user wanted to view or edit a piece of data; that is the basic idea of “software components”. For example, one programmer can write a software component to deal with spreadsheet tables, so that any table inserted in a document could be handled with the said software component. Thus, if another programmer needs to write code to manage some kind of data that includes tables, e.g. a calendar, the new software component does not have to deal with the burden of cell visualization or edition, since it can include a table for each month in the calendar and let the table handling component do the low-level cell management of each table.

In 1990, Microsoft introduced OLE (Object Linking and Embedding), a software architecture that allows inserting an object (a piece of data) produced with one program into the content managed by another program. The object can be referenced with a link that points to the original place of its data (typically, a portion of a file), or can be embedded into the data structure of the document that will include the inserted object (another file). This approach enables the user to build his/her information as a hierarchical structure of objects inserted into other objects, which defines the concept of “compound documents”. Today, this concept also applies to the case of a simple text editor that can manage an image as part of the text. However, the capabilities of OLE go much further than the typical copy and paste functionality, since it registers the original “category” of the inserted objects, so that the user can edit that data with the program used to originally create the object, within the user interface of the program that manages the document that contains the object. This technique is called “in-place activation”. In this manner, the original data is not lost when transported to other applications, and the manipulation of the data is independent from the environment where the object is inserted in.

In 1992, Apple joined with IBM and WordPerfect (and later on with other companies) in a partnership to offer an alternative to the Microsoft's OLE system, which was named as OpenDoc. The general ideas behind OpenDoc are essentially the same: a software architecture were the user's documents are composed of inner objects so-called “parts”, where each part can be edited in-place by a suitable editor. However, the working principle of OpenDoc that clearly differs from OLE is that the software components responsible for visualizing and editing each part can run independently of any particular application; one generic program called “document shell” acts as a generic framework to manipulate any OpenDoc document, provided that the software components corresponding to all contained parts are installed in the system. This leads to the concept of “document-centered computing”.

In the other hand, although the OLE technology certainly moved the Microsoft's software towards the “document-centered computing” paradigm, the OLE objects still have to be managed within classical applications such as Microsoft Word or Excel, which in turn are responsible for defining the general data framework for high-level documents (so-called “containers”) into which other objects can be inserted. For this reason, we can say that the OLE technology is one step behind the OpenDoc technology in the sense that the later shows more clearly the hierarchical structure of data objects to the users, while the former is more related to the “application-centered computing” paradigm because the users are not aware of the data interweaving produced by the use of OLE objects, and they still work with the mental model of “computer applications as data editors”.

Nevertheless, OpenDoc did not survive the market dynamics, in part because there were very few third-party developers committed with the new software architecture, and in part because Apple decided (in 1997) to concentrate its efforts in other fields, such as integration with Internet. Meanwhile, Microsoft also focused in Internet and, in 1996, introduced ActiveX, an adaption of the OLE components for web pages. Today, OLE and ActiveX are still in use because Microsoft required during a long period of time (more than 10 years) that any software package that aims to be certified by the Microsoft corporation must adhere to the protocols and interfaces stated by these architectures, although in practice the majority of component-based implementations are mostly constrained to the interoperability with Microsoft Office (for OLE 2.0) or Internet Explorer (for ActiveX controls).

Besides, there were other previous object-oriented systems, like the Carnegie Mellon University's Andrew toolkit (1985), the Dr. Ken Sakamura's BTRON system (1985), and the Hewlett-Packard's NewWave framework (1987), but none could helped in spreading the document-centered (or object-centered) view of user information, which succumbed to the domination of Microsoft's systems, and to the focusing of the industry towards the Internet and, more recently, Mobile and Cloud Computing.

Another source of problems for data usability is the file system approach to store the user information, based on specific data structures known as “file formats”. Although some common file formats are shared by several computer applications, the number of those formats has also experienced a huge increase since the majority of programs define their own file structure. This fact introduces the necessity for conversion tools for translating data files produced by different applications, which is more probable to occur when different users want to interchange their data. Also, this translation may result in data loses.

Furthermore, the organization of files in a hierarchical directory structure tends to an awkward dissemination of data, and users often get into difficulties when finding their own files within the tree-like distribution of directories that they themselves defined. To overcome these difficulties, computer operating systems provide file search mechanisms based on several criteria, though the more popular and powerful are those mechanisms, the more redundant the directory/file organization proves to be.

Besides, if any prepared software designer is asked to devise a computer framework to deal with a rather complex data structure, from the typical business organization in clients, products, services, invoices and accountability, to a specific set of scientific data such as DNA sequences, population census or climate measures, the solution will invariably be to define a database design that properly models the data semantics, to use a convenient database management system (DBMS) to deal with the storage and retrieval of the data, and probably to create specific programs to allow end users to easily interact with the contents of that database.

Databases have been intensively developed since 1962, as they demonstrated largely their multiple advantages in front of a file-based organization of data in terms of efficiency, concurrency, resilience and reusability (among others). Paradoxically, productivity applications like office packages and industrial or graphical design suites have been stuck into the file-system model since they appeared, using files with specific format for storing the data of each job or document. Several reasons led to this situation. One reason is that database managers are highly complex software, thus historically they were installed only on large computer facilities. Another reason is that the dominant type of databases has been the “relational database” since 1970, which only handles data that can be fitted into fixed-columns tables, hence it is a too rigid structure to hold heterogeneous data. A third reason is that the dominant language to deal with the database manager has been the “SQL”, which is also rather rigid for commanding data management in non-canonical manners. A final reason to mention is that the only means to extract a part of the data for sharing it with other users is to create a sub-database that will surely need a large amount of space, making it very difficult to transfer it to a removable media or through a computer network.

However, in the 1990s all these constraints stopped to be impediments, when powerful personal computers where available, more flexible “object-oriented databases” and “noSQL” languages appeared, and that it started to be feasible to transfer sub-databases in electronic media and through the network bandwidths of that time. But neither OpenDoc nor OLE used database managers to handle the naturally object-oriented structure of their documents. On the contrary, they used very cumbersome file structures to link or embed objects created with other applications, which lead to remarkable problems of access efficiency and data consistency. Moreover, it is almost impossible for several users to work simultaneously on OpenDoc or OLE documents, given the non-distributed (and therefore non-concurrent) nature of the Apple's Macintosh and Microsoft's Windows file systems.

There exists other approaches that enable end users to organize their information in an object-oriented style, for example, the ones disclosed in U.S. Pat. No. 5,303,379 (“Link Mechanism for Linking Data between Objects and for Performing Operations on the Linked Data in an Object Based System”, by Khoyi et al.), U.S. Pat. No. 6,606,633 (“Compound Document Management System and Compound Document Structure Managing Method”, by Tabuchi), U.S. Pat. No. 6,973,656 (“Method and Apparatus for Linking Data in a Distributed Data Processing System”, by Huynh et al.) and U.S. Pat. No. 7,376,895 (“Data Object Oriented Repository System”, by Tsao). All these approaches provide mechanisms for storing data as compound objects of given types (text, graphic, table and so on), for adding new data types, and also for allowing software components to let the task of handling the data to a specific object database manager, as well as other remarkable features (version history, data change notifications, cooperative working, etc.). Nevertheless, the proposed database managers ultimately distribute the content of the objects into files and folders, which is certainly an inappropriate decision considering the benefits of fully storing the data into an object-oriented database, and also considering the triviality of implementing such option. Besides, those approaches still provide a user interface that is clearly inherited from the application-centered view, since all software components show up within a certain application context, thus forcing the user to think in terms of the available software tools instead of focusing on the data content and structure.

### SUMMARY OF THE INVENTION

In view of the aforementioned problems of current object-based systems for managing end-user information, the main object of the present invention is to provide such an environment that actually enables users to handle pure data objects with total independence of managing software tools and without relying on any file system.

A preferred embodiment of the invention comprises any personal computer system composed by central processors, random access memory and a plurality of input/output devices, all of which executing a regular operating system that provides a framework to execute an object-oriented database by a software manager, which will handle all data objects of the system for management of information, and also the framework to execute the software components that may control a user interface, e.g. a Java Virtual Machine for executing Java byte-code. The proposed structure of the system for management of information is designed to be such flexible that it can be extended (or reduced) as the end user needs more (or less) functionality.

Other embodiments may be devised, such as to distribute user data across computer networks so that the user may have data access from different computer facilities. Furthermore, the software components may also be executed on remote computers, so that the user may only need a computerized device equipped with an Internet browser to run the system for management of information.

According to a first aspect, the invention relates to a system for integrated management of end-user information, being that system composed of a unique computer application and a single object-oriented database, where said unique computer application and a software manager for said database are stored and executed on a computer device, said unique computer application providing means for creating and editing objects of information of different types, said type of information including at least text, images, tables, graphics, formulas, sounds, videos, said objects of information of different types being organized into hierarchical structures providing high-level structured documents such as reports, books, e-mails, presentations, web pages, blogs, and being all of said high-level structured documents recorded into said single object-oriented database.

Preferably, said objects of information of different types are identified by a type identifier and an object identifier, being the type identifier a unique number for each type of information, and being the object identifier a unique number within a specific range of each type of information. Additionally, each type of information is described in terms of data fields and metadata fields, where said data fields register the intrinsic content of the object of information and said metadata fields register some attributes about the data content including language, name and description of the objects of information. As per this invention, the proposed unique computer application is compound of a plurality of software components that can be included in or excluded from the application to provide specific functionality for implementing management of specific high-level structured documents.

In accordance with some embodiments, any object of information may be included or inserted into another object of information independently of the types of the information of said data objects, so that a user can easily build any number of said high-level structured documents. In fact, each of the high-level structured documents are objects of information themselves, thereby they can be included into other compound documents (e.g. to include a report into an e-mail, and to include that e-mail into a blog) or into another object of information (e.g. to include a video into a cell of a table, and to include that table into a text). Each inclusion does not imply replication of data, because the system works with references (links) to each object of information. Therefore, a change in the content of the original information or data of an object results in the automatic update of the information or data in every place where that object is inserted in.

In accordance with some embodiments, the invention further comprises means for managing menu interfaces executed on said device computer, said menu interfaces being composed of a plurality of menus which are in turn composed of a plurality of menu items, implying the management of specific of said high-level structured documents, being said menu interfaces, said plurality of menus and said plurality of menu items associated to a specific type of information for which the actions of a specific toolkit can be applied by means of an action reference included in each menu item. Means are provided for allowing said user to select among a plurality of menu interfaces for a given type of information to be edited, according to the type of information for which the menu interfaces apply, including menu interfaces that apply to ancestor types of information, so that the user will be allowed to install or uninstall the desired toolkits, as well as the possibility to configure preferred menu interfaces and to choose the convenient menu interface at each moment.

An object-oriented database software manager is the entity responsible for providing the means for storing the information of a user. The database scheme defines a convenient identification for all the objects of information, and the database manager allows storing and retrieving the content of each object of information referenced by its corresponding identifier. Therefore, the proposed system for managing information does not utilize a file system approach to store the user information. Instead, the present invention offers a new organization scheme for objects of information of the user, which is independent from the software components.

According to a second aspect, the invention relates to a method for integrated management of end-user information, using a unique computer application and a single object-oriented database, where said unique computer application and a software manager for said database are stored and executed on a computer device, wherein said method comprising using said computer device for:
creating and editing objects of information of different types, said type of information including text, images, tables, graphics, formulas, sounds, videos providing high level structured documents by organizing them into hierarchical structures;
recording all of said high-level structured documents into said single object-oriented database; and
importing new types of information or deleting existing types of information implying the management of specific types of information for describing the type of information itself and the related data and metadata fields.

In accordance with some embodiments of the method, new types of information derived from existing types of information are also specified, which implies the reuse of fields defined in an ancestor type of information, as well as the functionality of the related software components. Furthermore, the method comprises managing by the referred computer device toolkits of actions to be performed on specific types of information, hence allowing a user to import new toolkits or actions or delete existing toolkits or actions, which implies the management of specific types of information for describing the toolkits and the actions and the software components for executing the actions. Besides, actions defined for an ancestor type of information are similarly executed onto objects of information of a derived type of information for overriding existing actions defined for ancestor types of information and for invoking actions of an ancestor type of information from within an action defined for a derived type of information.

The method of the invention further provides means for handling the positioning and formatting of the inserted objects of information in the hierarchical structures with total independence of the object editing software. This is accomplished by defining “frames”, which encapsulate a given object of information and are responsible for its presentation within a container object of information, attending to the available space, positioning constrains and formatting options. Each frame holds a link to the object of information, so the information of the object exists only once within the system storage, although may be inserted within many other objects of information with a particular presentation at each place. For example, one may have a common text (e.g. personal address) defined as a text object, which can be inserted into other data objects such as text documents or images or tables, etc. with one specific text style (font, size, color, etc.) at each different location. The formatting and layout procedures are included in special software components called framers and allowing the user to import new framers, or delete existing framers.

For instance, internal frames are positioned within a parent frame, so that a corresponding framer of the said parent frame can position the internal frames according to geometrical relations between the said internal frames, and for synchronizing the position and formatting of internal frames of the said parent frame inserted in other frames. Or, the content of an object of information is fitted enclosed by a frame into an inner shape of at least an area smaller than the outer rectangular bounds of said frame, said inner shape being delimited by other inner shapes of internal frames or sibling frames of said frame, and scaling and rotating the inner shape or the information of the object (object content) itself.

According to a further proposal of the method of this invention all the user objects of information of different types are organized in heterogeneous groups called projects and user objects of information of the same type in homogeneous groups called sets and subsets, where each one of said projects contains a unique set for each type of information, and the objects of information of the same type in each set are organized into a plurality of subsets. Thus, one user may have several projects, each one referring to different jobs or tasks, and each project may have its specific collections of documents, e-mails, web pages, tables, images, texts, etc. As a specific example, suppose that the user has traveled (or is planning to travel) to a foreign country, and that he or she has collected several kinds of information: hotel guides, activity brochures, photos, e-mails exchanged with hotel for booking a room, and so on. The user may create a specific project for that travel (with a descriptive name, e.g. “Canada, summer 2013”), and put all related pieces of information into that project. Since there exists only one set per each data type for each project, each kind of data will be automatically stored in the corresponding set (documents, images, e-mails, etc.). Moreover, the user may define arbitrary subsets for each set. For example, in the set of documents there may be a subset for “brochures”, another for “hotel guides”, etc. An object of information contained in a subset will automatically be contained in the corresponding set of that type for the project. An object of information can be contained in any subset or set of its corresponding type within any project, although the object content is stored only once into the object of information database. One has to note that this is not a substitution of a directory hierarchy, because subsets cannot be included into other subsets and objects of information must be included only in sets of its type. The purpose of a limited though conceptual hierarchy of object of information repositories in the shape of “projects/sets/subsets” is to provide the user with a meaningful yet flexible structure to locate the objects of information. This approach does not exclude the possibility to devise global information searching mechanisms, although the present application does not makes provisions for such mechanisms.

In accordance to a preferred embodiment, the method described is capable of managing several viewers of the objects of information contained in any set or subset. Each viewer is a software component that can be installed in or uninstalled from the system according to the user necessities, and that is aimed to show a group of objects of information in a certain form. For example, one may wish to view all photos contained into a set (or subset) as a textual list, showing the name, size, date and time, place and other textual attributes of each photo object. Another manner to view the same collection of photos is as a matrix of small snapshots. Yet another manner is to place the snapshots on a map, according to the GPS coordinates of each photo (if available). Alternatively, one may wish to view the snapshots on a calendar, according to the date of each photo. Moreover, all these different viewers (“textual list”, “snapshot matrix”, “map” and “calendar”) may also be used to show other types of information (documents, e-mails, songs, etc.), provided that the objects of information of those types have the necessary attributes. For example, the textual list viewer requires that each object of information has attributes for recording its name, size, date of creation or modification, and so on, whereas the snapshot matrix viewer requires the each object of information has an attribute for recording a small picture. These attributes are information or data related to the object, although they may be not part of the data fields (content) of the object of information, thus they are known as “metadata”.

The method also comprises managing different linguistic versions of the same object of information of any type, including a language identifier for each version and a plurality of specific descriptors for each version, included in a locator of the object of information, forming said versions a group called Babel bubble, and enabling the user to change between the representation of the object of information by choosing among the available languages, and to add new linguistic versions to, or delete existing versions from said group of linguistic versions.

All the aforementioned capabilities of the present invention, as well other features like automatic zooming of object content, will be explained thoroughly in the detailed description of the invention.

### BRIEF DESCRIPTION OF THE DRAWINGS

The previous and other advantages and features will be more fully understood from the following detailed description of embodiments, with reference to the attached drawings, which must be considered in an illustrative and non-limiting manner, in which:

FIG. 1 is a block diagram of a generic hardware system (gray-shaded blocks) and basic software elements (145, 150, 160 and 170) which provide a convenient execution framework for the present invention (180).

FIG. 2 is a block diagram of the main software elements of the present invention, represented as “managers” (squared blocks) and instances of what is managed (rounded blocks), which in turn may reference other software components.

FIG. 3 shows the generic structure of system objects as well as user objects of information.

FIG. 4 illustrates the structure of an “object locator” and its relation to the user object of information that it references.

FIG. 5 is an illustrative example of a “Babel bubble” of an object with textual content translated to several languages, and the corresponding locator descriptors of such linguistic versions.

FIG. 6 illustrates the structure of a “hierarchic frame” for representing the hierarchical inclusion of objects of information inside other objects of information.

FIG. 7 is an example of a hierarchic structure of a document composed of different objects of information.

FIG. 8 is a graphical representation of the frame structures and references to two objects of information of the example shown in FIG. 7.

FIG. 9 shows the structure of three types of “positions” that may represent the position of an included frame within the container frame.

FIG. 10 represents several examples of positioning one frame inside another containing frame, according to the container coordinates space (a to d) and according to another contained frame (e to h).

FIG. 11 is an example of several placement of the same object of information within the same parent frame, illustrating the synchronization feature of the positions.

FIG. 12 shows the structure of a system object for representing object types, as well as another system object for representing the fields of such types.

FIG. 13 is an illustrative example of a derivation of a type into another type.

FIG. 14 is another example of derivation, more specifically for showing the inclusion of different objects of information as fields of another type, as well as field inheritance.

FIG. 15 shows the structure of a system object representing a toolkit, i.e. a set of actions that can be applied to a particular type of information, as well as the structure of another system object representing an “action identifier”, which will define the list of actions of a given toolkit.

FIG. 16 is an illustrative example of two toolkits for defining actions for two types, one derived from the other, and a list of actions for each toolkit, where one action for the ancestor type is overridden by another action in the toolkit for the derived type.

FIG. 17 illustrates an example of the user interface panel for showing and selecting among several projects, sets and subsets.

FIG. 18 shows the structure of three system objects for representing the content and relations of projects, sets and subsets.

FIG. 19 illustrates an example of the user interface panel for viewing a group of objects of information contained into a set or subset.

FIG. 20 shows the structure of a system object representing a viewer.

FIG. 21 illustrates an example of the user interface panel for showing and editing the content of an object of information.

FIG. 22 refines the example in FIG. 21, by showing the selection of an inner object of information and the zooming feature for focusing the attention onto a selected sub-object.

FIG. 23 shows the structure of three system objects for representing the user interfaces for editing objects of information, in the form of “menu interface”, “menu” and “menu item”.

FIG. 24 shows the structure of a system object-representing a framer.

FIG. 25 is an illustrative example of several frames inserted into each other, and how this can modify the layout of the frame content, by means of inner limiting shapes.

FIG. 26 shows several examples of frame and object of information scaling factors.

FIG. 27 shows several examples of shape and object of information rotating factors.

### DESCRIPTION OF PREFERRED EMBODIMENTS

The invention is preferably practiced in the context of an operating system for integrating management of end-user information resident on a personal computer, which incorporates a Java Virtual Machine (Standard Edition) that executes Java byte-code. However, other object-oriented languages that render capabilities similar to Java may also be utilized. Moreover, the context must also incorporate an object-oriented database manager for storing and retrieving the content of the data objects, although there exists means for translating object-oriented queries to other types of database managers, such relational databases. In any case, it should be understood that the invention may be embodied in many different forms and should not be construed as limited to the embodiments set forth herein.

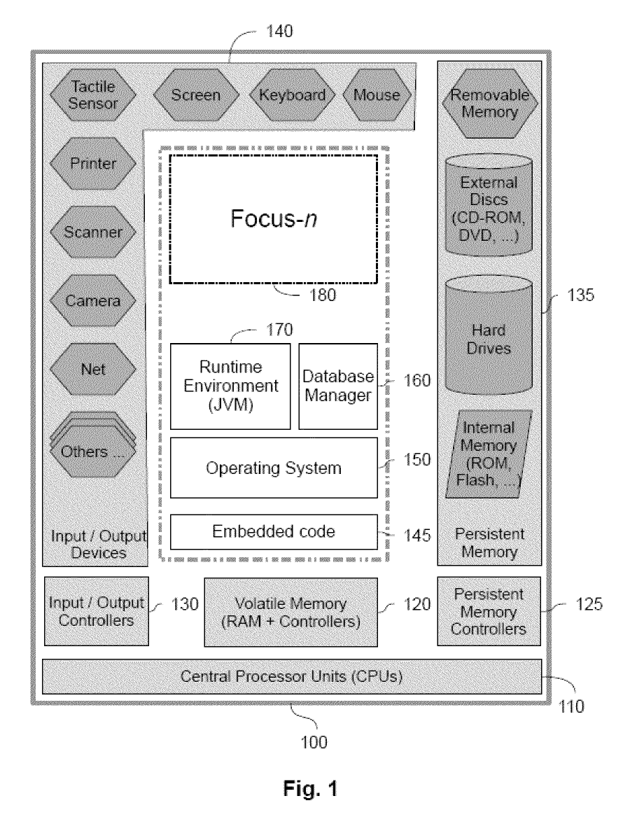

FIG. 1 shows a symbolic block diagram of a generic framework 100 for the provided system and method for integrated management of information. It consists of hardware blocks (gray-shaded) and software blocks (in white). The hardware provided by a personal computer, server computer, or other computing device such as smartphone and tablet PC, is basically composed of one or more Central Processor Units (CPUs) 110 for executing the software code, a Random Access Memory (RAM), so-called Volatile Memory, and its controller 120 for temporary holding the software code and data, other controllers 125 for Persistent (non-volatile) Memory devices 135, such as Read Only Memory (ROM), Flash Memory, Hard Drives, External Discs (CD-ROM, etc.) or other sorts of Removable Memory (pen drives, memory cards, etc.), for storing the software code and data when the computer is turned off, and a collection of Input/Output Controllers 130 for managing the input/output devices 140, such as Mouse, Keyboard, Screen, Network connection, etc., that make possible for the computing device to interact with the outer world, as well as other circuitry (not described in the diagram) that binds everything properly.

The system for integrated management of information 180 is called Focus-n. It uses a software framework composed of the Embedded code 145, that does the most basic handling of the machinery, the Operating System 150, that provides generic means for executing programs, a Database Manager 160, which will handle the content of the data objects, and a Runtime Environment for executing the Java byte-code of Focus-n, so called Java Virtual Machine (JVM) 170. Obviously, in the case that Focus-n was written in another programming language, other runtime environment would be necessary.

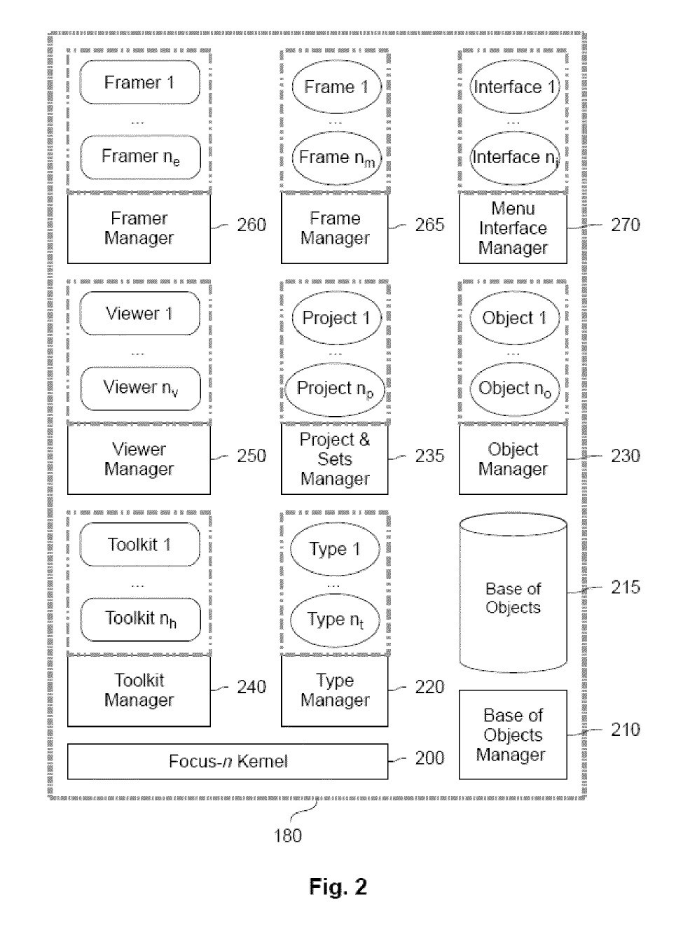

FIG. 2 refines the internal structure of Focus-n 180. The Kernel bloc 200 includes the code and data for the most basic working of the system for management of information. For the rest of the diagram, the software subsystems are referred as “managers” (in squared blocks) because they are responsible of handling specific data entities (in rounded blocks).

The Base of Objects Manager 210 corresponds to Focus-n code that communicates with the Database Manager. The Base of Objects 215 is a symbolic representation of the object database of the Focus-n system, although the database is actually stored in a persistent media, such as a hard drive.

The Type Manager 220 provides means for controlling (identifying, importing, deleting, etc.) the available types of information. One can observe that each type is represented as an object of information (Type 1, . . . Type nₜ), which is a strategy to allow updating the collection of types without the need for rebuilding (recompiling) the system for management of information. However, these strategy requires that the programming language can create objects at run-time (dynamically) from a “code block” that represents the structure and behavior of the user object of information (e.g., an object-oriented instance of a class or prototype), as the Java language does.

The Object Manager 230 is responsible for tracking generic data objects in use on volatile memory, which is necessary because it is not efficient to process the information or data of the objects directly on the persistent memory of the database.

The Project & Sets Manager 235 handles the content of all user projects and their included sets and subsets, which are held on volatile memory for efficiency reasons. Of course, any change in any generic object, type object, project, set or subset will be reflected on the corresponding instances of the database by the corresponding manager.

The Toolkit Manager 240 tracks the toolkits installed in the system. Analogously, the Viewer Manager 250 and the Framer Manager 260 enable the user to install or uninstall different viewers or framers for different types of information. Indeed, toolkits, viewers and framers are parts of the system for management of information, which makes it relatively easy for the user to adjust the capabilities of Focus-n to its necessities, although it requires that the programming language can load dynamically and execute the “code blocks” corresponding to those software components, as the Java language does.

Moreover, the framers handle the visualization of objects and sub-objects, by means of frames, so there is a Frame Manager 265 that controls all frames of the current objects in focus. Again, each frame is an object of information, and should be loaded from the database into volatile memory for efficient handling, and later stored again in the database to record any changes on the state of frames.

Finally, there is a Menu Interface Manager 270 that is responsible for the objects of information representing menu interfaces, menus and menu items, which describe and allow reconfiguring the available user interfaces for each type of information.

All these mentioned software components will be described more thoroughly in the following sections.

### Generic Object Structure

The data structures that will be shown thereinafter refer to fields of data packages, which are ultimately composed of arrays of binary codes. It must be clearly stated that an object of the Focus-n system is not directly related to an object of an object-oriented programming language, the latter being defined by its class (or prototype) and containing some fields of data and being associated to some methods for processing that data. Focus-n objects of information or data objects are essentially information containers, and the structure of such information is defined by the type of the information. Though, each object of information may well be implemented at run-time as an instance of a specific object-oriented class.

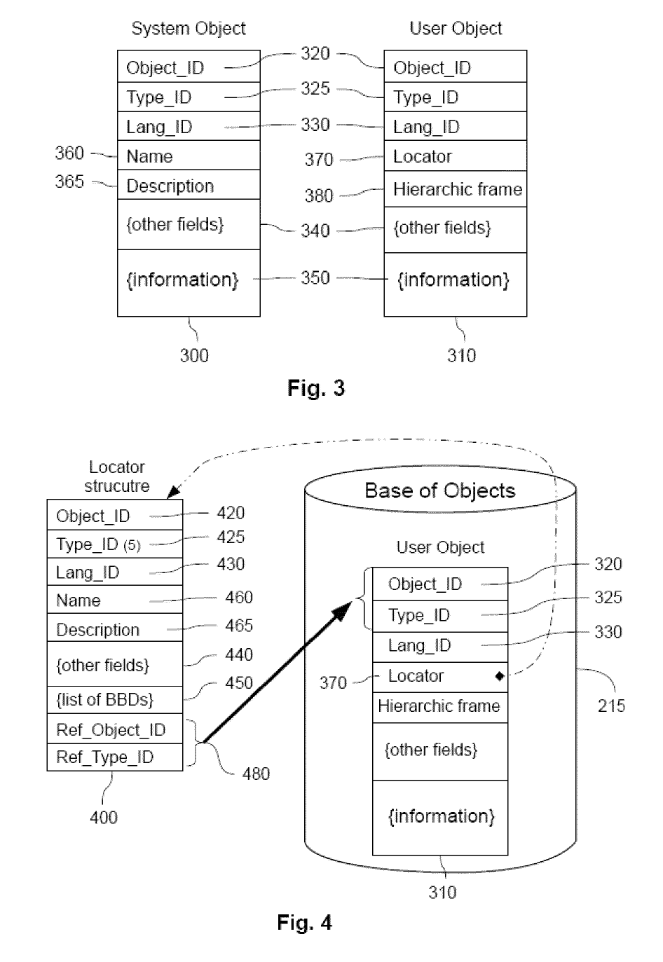

FIG. 3 shows the generic structure of System Objects of Information 300 and User Objects of Information 310. The invention separates these two kinds of objects implying that there are also two kinds of types of information, the system type and the user type.

System Objects of information and system type account for information particular to the system or of the system itself: toolkits, menu interfaces, viewers, framers, frames, locators, etc.

On the other hand, User Objects of Information and user type account for specific information of the user: text, images, tables, documents, projects, groups, etc.

Therefore, the system objects are used to describe the internal structure of the system itself. Thus, the same database is able to record the components that are installed in the system and the ability to manage them (lists them, add new ones, delete them, etc.). Anyway system objects pertain also to a user in that they describe the internal structure of the system that uses a specific user, but do not contain own user information.

Besides, system objects do not support the inclusion of other objects (either system or user), which makes them inherently different from user objects of information.

Both kinds of objects 300 and 310 present the same two fields for identification purposes: the Object_ID field 320 is the unique number of the object for the corresponding type, which is defined by another unique number in the Type_ID field 325. This means that each type of the Focus-n system must have assigned a unique number, and that the numbers of the objects must be unique only within the group of object identifiers of the corresponding type. For example, it can exist a text object with Object_ID=1 and an image object with Object_ID=1, but it cannot exist two text objects with Object_ID=1. The numbers for Type_ID must be manually assigned by a centralized organization, to avoid conflicting numbers in types created by third-party programmers. As an ad hoc rule, the system types will have identification numbers below 1000, and the user types will have identification numbers above 1000. The numbers for Object_ID will be automatically assigned by the Type Manager as new objects of each type are created. Therefore, each object of information is univocally identified by these two fields 320 and 325.

The Lang_ID field 330 is the numeric identifier of the language in which the textual fields of the object of information are written. This field allows having several linguistic versions of the same object. For example, it can exist a text object with Object_ID=1 and Type_ID=1004, but written in two or more languages, which will generate two or more instances of the same object, e.g. with Lang_ID=3 (English) and Lang_ID=10 (German). This multiplicity of the same object (with the same Object_ID and Type_ID) is handled with the “Babel bubble” concept, which will be explained below.

But the language specification also applies to metadata fields, i.e. fields that contain attributes for describing the information or data of the object. Examples of metadata are the Name 360 and Description 365 fields of a system object, which will provide for a textual identification and description of the object of information for the user to recognize that object. Therefore, a system object can be described in several languages. For example, the types of information are represented by system objects, hence the user may view the installed types by name (and description), and consequently the user may choose among the available languages for reading that list of types. Extending this capability to all system objects makes it possible to change the language of the whole user interface by means of a mere selection of the available Lang_ID values of the system objects.

The entry {other fields} 340 is a placeholder for other metadata attributes of the two kinds of object types, whereas the {information} placeholder 350 stands for the fields that actually contain the information or data of the object. For example, for an image object, the {information} may be the binary codes for the color of each pixel, and the {other fields} may be the size of the image, as well as a snapshot of the image. Another more generic metadata may be the number of references to the object, which indicates how many occurrences of the object there are within other objects.

The remaining specific fields for user objects 310 are the Locator 370, used to identify the object of information from within other elements like sets or frames, and the Hierarchic frame 380, used to construct the “essential frame” of the object of information, i.e. the frame that holds the object of information itself, not within other objects. These concepts will be explained more deeply in next sections.

### Object Locators

FIG. 4 shows the generic structure of a Locator 400, which is a system object with a specific Type_ID (5) 425, a unique Object_ID for each locator instance 420, and the corresponding Lang_ID 430 for the Name 460 and Description 465 of the user object 310, which is referred by the locator with the pair of fields Ref_Object_ID and Ref_Type_ID 480. Thus, the locator field 370 of each user object 310 contained in the Base of Objects 215 must set the Ref_Object_ID and Ref_Type_ID fields equal to the Object_ID field 320 and Type_ID field 325. The Lang_ID field 430 of the locator may be equal to the Lang_ID field 330 of the user object, but it is not strictly required (see the “Babel bubbles” section).

Although it may seem redundant to define a specific field to refer to the object of information that it contains, locators are useful for referring said object from other elements, like sets or frames. For example, a set (or subset) essentially defines a list of the locators of the objects of information contained in the set. In this manner viewers can display lists of objects of information without the need to access the content of the listed objects, if the {other fields} placeholder 440 provide the required metadata attributes, such as size, date and time of creation or modification, author identification, permissions, etc. If the viewer requires other attributes that are not part of the common ones, then the viewer will have to access the content of the objects of information. Since the content of the locators is relatively small in size, the viewer may well be able to load the whole list of locators into volatile memory, but it will not be able to load all objects of information into volatile memory, because the content of the objects of information may be significantly large.

Moreover, locators also provide means for tracking all linguistic versions of the user objects of information, through the {list of BBDs} field 450, which will be described in the following section.

### Babel Bubbles

A “Babel bubble” is a group of linguistic versions of the same user object of information, i.e. a group of object “instances” with the same Object_ID and Type_ID values. Indeed, all these object instances represent the same “logical” user object, but the Babel bubble concept allows the user to choose among them to read the textual content in a specific language.

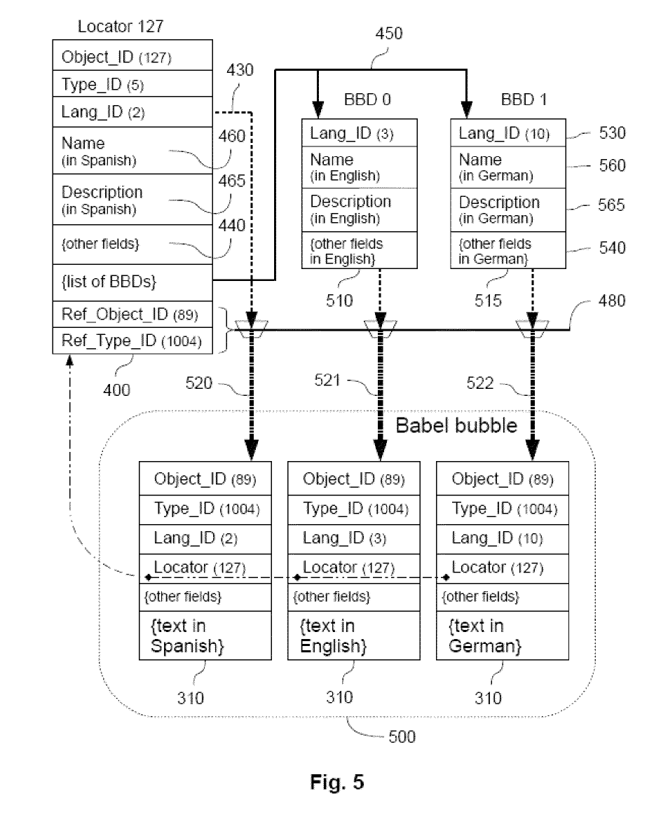

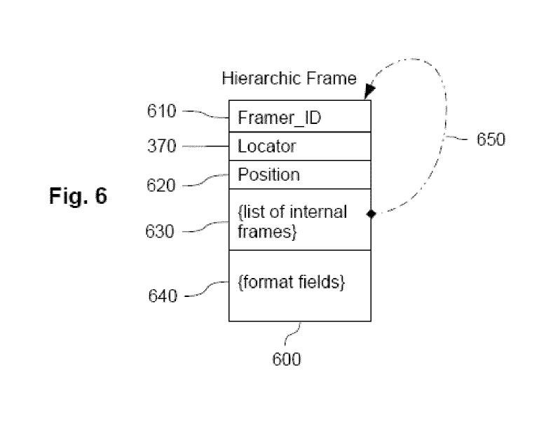

FIG. 5 is a graphical representation of an example of a Babel bubble 500 with three instances of the same user object of information 310. All those instances have the same Type_ID (1004) and Object_ID (89), but differ in the Lang_ID (2, 3 and 10), which means that they are written in Spanish, English and German, respectively. Moreover, the three instances share the same locator 400, which has Object_ID=127. Since the Lang_ID 430 of this locator is 2, it implies that the name 460 and description 465 of the user object of information are written in Spanish. If there are {other fields} 440 with textual content, such as the date of creation, they will also be expressed in Spanish.

To allow locators to contain textual fields in other languages, another data structure called “Babel Bubble Descriptor” (BBD) is used, a list of which is contained in the field 450 of the locator. The fields of each BBD are exemplified in the instances BBD 0 termed 510 and BBD 1 termed 515. Basically, they consist of a Lang_ID field 530 that indicates the language of the BBD, a Name 560 and Description 565 fields, for describing the user object of information in the referred language, and a {other fields} placeholder 540 for all metadata attributes of the locator that may need be translated to the referred language.

The list of BBDs not only enable writing the textual fields of the locator in several languages, but also identifying the several linguistic instances of the user object of information referred by the Ref_Object_ID and Ref_Type_ID fields 480 of the locator. In fact, the proposed system for integrated management of information combines these reference fields with the Lang_ID field of the locator itself and the Lang_ID fields of the available BBDs in an Object_ID/Type_ID/Lang_ID triplet that points to each object instance. In FIG. 5, there are three combinations 520, 521 and 522 that point to the three versions of the user object of information. The system is responsible for generating the corresponding BBDs and to query the database manager with the correct triplet for accessing the required linguistic version of an object.

In the case that the content and metadata attributes of the object of information are language-independent, e.g. an image, there will be only one instance of the object with Lang_ID=0, although the name and description fields of the corresponding locator will be expressed in one specific language and there may be several BBDs for other versions. Thus, the system generates the same triplet (with Lang_ID=0) in spite of the multiple descriptive versions referring the same user object of information. Furthermore, the system will not permit to have other linguistic instances of a language-independent object of information.

### Hierarchic Frames

A “Hierarchic frame” is a data structure for representing the inclusion of a user object inside other user objects of information. FIG. 6 shows the fields of such structure 600, which contains an identifier of the framer (Framer_ID) 610 that controls the frame, a Locator 370 of the object of information enclosed by the frame, a Position 620 for specifying the position of the frame within a “parent” frame (another frame that contains this frame), a list of other hierarchic frames 630 that are internal to this frame, and a set of {format fields} 640 that may configure the shape and layout of the content of the referred object of information within the available space of this frame.

Every user object has an essential frame, which is the frame that encloses the object of information itself, and is defined in the field 380 of the user object structure 310 of FIG. 3. However, each user object can be enclosed in other internal frames, i.e. inside other objects of information. This is possible due to the hierarchy defined by the list of internal frames, graphically expressed in FIG. 6 as a reflexive arrow 650. The list includes the frames that enclose the objects of information inserted in the “top” object, but each internal frame can define its own list of internal frames for other objects of information inserted within the “child” objects, and so on. This mechanism provides for the definition of a hierarchical structure of inserted objects of information.

Moreover, it must be noticed that each hierarchical structure is different at each occurrence of the same object of information. For example, one image object may contain a text object in its essential frame, but it is perfectly possible that the same image is inserted into a third object of information and, within the frame hierarchy of the third object, the image may contain the same text object, a different text object, other objects or none objects at all, because the list of internal frames of the third object of information is completely independent from the list of internal frames of the essential frame of the image object.

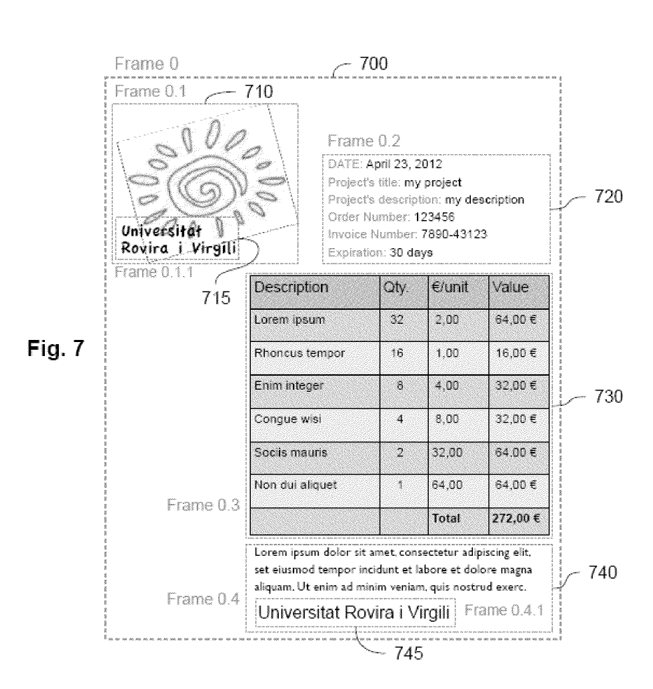

FIG. 7 illustrates an example of a compound object of information, the essential frame of which is labeled as “Frame 0” 700. This object of information contains an image object within “Frame 0.1” 710, a text object within “Frame 0.2” 720, a table object within “Frame 0.3” 730, and another text object within “Frame 0.4” 740. At the same time, internal frames 710 and 740 contain the same text object enclosed in respective second-level internal frames “Frame 0.1.1” 715 and “Frame 0.4.1” 745.

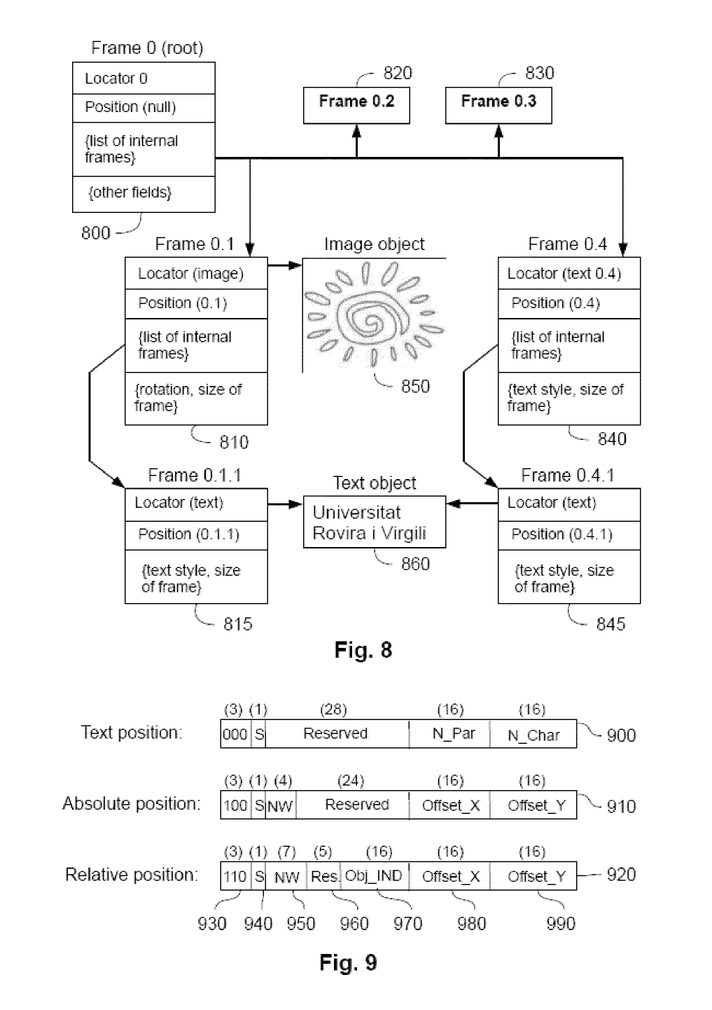

FIG. 8 is a graphical representation of the hierarchic frame structures corresponding to the example of FIG. 7. The “root” frame 800 does not define any position (null) because it is an essential frame, but defines the list of internal frames containing the structures for frames 0.1 810, 0.2 820, 0.3 830 and 0.4 840. The frames 0.1.1 815 and 0.4.1 845 are included in the corresponding internal frame lists of frames 810 and 840. In this FIG. 8 it is also represented the reference to the image object 850 and to the text object 860 by the locators of the respective enclosing frames.

Since every frame structure can set different values for the {other fields} attributes, the end user will be able to assign different formatting options to the same object of information inserted in several places. This is the case of the text object 860, which is formatted with two different text styles while the text content keeps invariant.

### Positions

A “Position” is a packed-bit structure that provides information about how an internal frame must be positioned within the space of the frame that contains it (its parent frame). In a possible embodiment, FIG. 9 suggests a 64 bits data value. Further, the three most significant bits 930 indicate the kind of the position. The S bit 940 is another bit-field that is common to all kinds of positions, although it will be better explained in the context of an example (see below).

FIG. 9 proposes three kinds of positions:

The “Text position” 900 is intended for internal frames inserted in a concrete point of a text object, by means of indicating the paragraph and character position in the 16 bits bit-fields N_Par 980 and N_Char 990, respectively. Hence, the framer that is responsible for laying out a text object will also be responsible for placing any internal frame specifying a text position. The inserted frame is treated as another character, so the line of text that contains that frame must be shifted to the bottom to provide enough space for the frame height, and the characters after that frame must be shifted to the right (or to the left, depending on the script direction) to provide enough space for the frame width.

The “Absolute position” 910 is intended for internal frames inserted in a graphical position of the parent frame, by means of indicating an “anchor reference” in the 4 bits NW bit-field 950 and the graphical X and Y offsets with respect to the anchor in 16 bits bit-fields Offset_X 980 and Offset_Y 990, respectively. The anchor references are the corners or the middle-edge points of the parent frame and the inserted frame, with a binary code starting from ‘0000’ for the top-left corner, and continuing clockwise to ‘0111’ for the middle point of the left edge, and a ninth code ‘1000’ to indicate the center of the frames.

The “Relative position” 920 is intended for internal frames whose graphical position must be specified with respect to another internal frame of the same parent frame, i.e. a “sibling” frame, by means of indicating an “anchor reference” in the 7 bits NW bit-field 950, the index of the sibling frame in the 16 bits Obj_IND bit-field 970, and the graphical X and Y offsets with respect to the anchor in 16 bits bit-fields Offset_X 980 and Offset_Y 990, respectively. In this case, the anchor reference is composed of 7 bits because there are two reference points, one for the sibling frame and another for the frame to be positioned. The six right bits indicate the anchors of sibling and positioned frames using the same code introduced for the anchor references of an absolute position, and the left bit is used to express that both frames must remain centered.

In the three kinds of referred positions, the remaining bits of the position are labeled as Reserved (or Res.) 960, as a variable-length bit-field that is reserved for future uses.

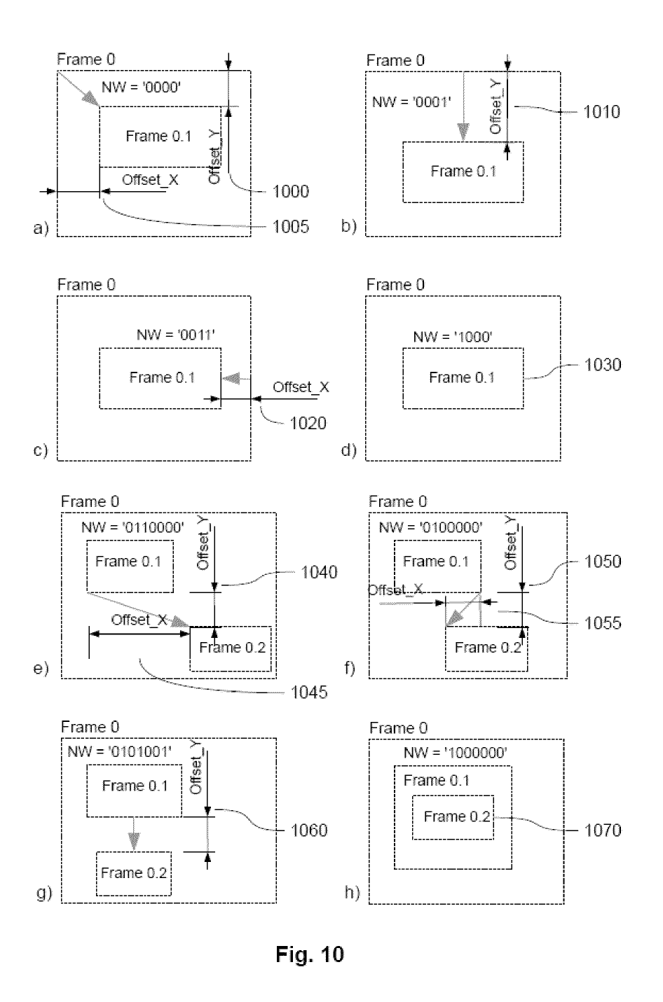

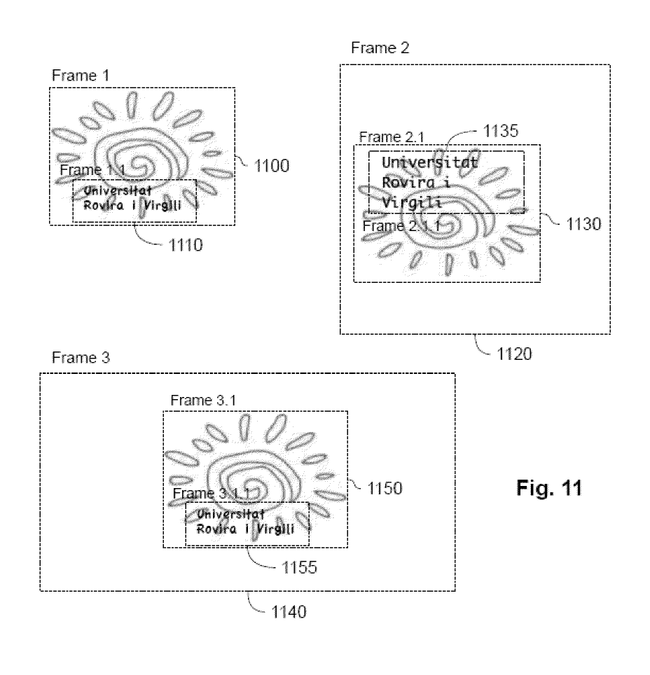

FIG. 10 shows different examples of absolute and relative positioning. The examples a) to d) correspond to four absolute positioning of an internal “Frame 0.1” with respect to a parent “Frame 0”. In example a), the anchor reference is the top-left corner (‘000’), so the Offset_Y 1000 and the Offset_X 1005 indicate the displacement between the corners of both frames. In examples b) and c), the anchor references are two middle-edge points, one for the top edge (‘001’) and the other of the right edge (‘011’), hence the displacements are indicated by the Offset_Y 1010 and the Offset_X 1020, respectively, and the displacement for the other coordinate is computed automatically by the framer to align the corresponding middle-edge points. In example d), the origin of the internal frame is computed automatically by the framer to keep both centers coincident 1030.

Positive offsets always indicate inner displacements of the referred anchor point of the internal frame within the space of the parent frame. However, some area of the internal frame may fall outside of the parent frame bounds. Besides, it is also possible that the end user enters negative offsets, which surely provokes this effect. In both cases, the framer must command the graphical environment to clip the outer area.

The examples e) to h) correspond to four relative positioning of an internal “Frame 0.2” with respect to a sibling “Frame 0.1”, both within a common parent “Frame 0”. In example e), the NW code indicates that the anchor reference for the sibling frame is the bottom-left corner (‘110’), whereas the anchor reference for the positioned frame is the top-left corner (‘000’), hence Offset_Y 1040 and Offset_X 1045 determine the displacement between these two corners. Example f) is similar to e) but with a displacement respect to the bottom-right corner of the sibling frame (‘100’) and with a positive Offset_Y 1050 and a negative Offset_X 1055, which shows that negative offsets for relative positions does not imply clippings of the internal frame area. Example g) shows a displacement between two middle-edge points, the bottom one (‘101’) of the sibling frame and the top one (‘001’) of the positioned frame, and a positive Offset_Y 1060 that defines a constant distance between both frames, while the Offset_X will be ignored because the framer (corresponding to Frame 0) will keep both middle points horizontally aligned. Finally, example h) shows the case where the positioned frame keeps centered 1070 with respect to the sibling frame. The position mechanism proposed in this application, with the help of at least a computer device, will allow end users to set the layout of compound objects of information with relative easiness, because users only should have to specify clear constraints, such as “this object of information has to be shifted that distance from the top edge of the parent object of information”, and the framer will be responsible to the relocation of the frames when any implicated variable is changed, for example, the width of the parent frame. Obviously, the user will not be allowed to create transitive dependencies between the positions of two or more sibling frames, for example, a first frame must be at the left of a second frame by some distance, and the second frame must be centered to the first frame.

FIG. 11 is an example of a synchronization of the position and formatting attributes of the same inner object inside the same parent object of information, which is regulated by the bit S of the generic position layout (see FIG. 9). In the example, there is an image object with an essential “Frame 1” 1100 that contains a text object within an internal “Frame 1.1” 1110. The image object is inserted into two other objects of information with essential frames 1120 and 1140, what requires to define internal frames for the image object and its included text object, being named as “Frame 2.1” 1130 and “Frame 2.1.1” 1135 for “Frame 2”, and “Frame 3.1” 1150 and “Frame 3.1.1” 1155 for “Frame 3”. Suppose that the position of frame 1135 has the bit S=0, and the position of frames 1110 and 1155 have the bit S=1. In such situation, the system for management of information will keep synchronized the position and formatting of the text object within the essential frame 1100 and within the internal frame 1150, so that any change made in one frame will get automatically reflected on the other frame and vice versa, whereas the formatting and position of frame 1135 will not be modified since it is not synchronized.

The provided method for frame synchronization has the purpose of assuring that the appearance of one compound object of information remains equal in all places where it appears, but also allow the opposite situation when the user needs to perform local changes on the layout of a compound object of information without modifying the rest of the occurrences.

### Types

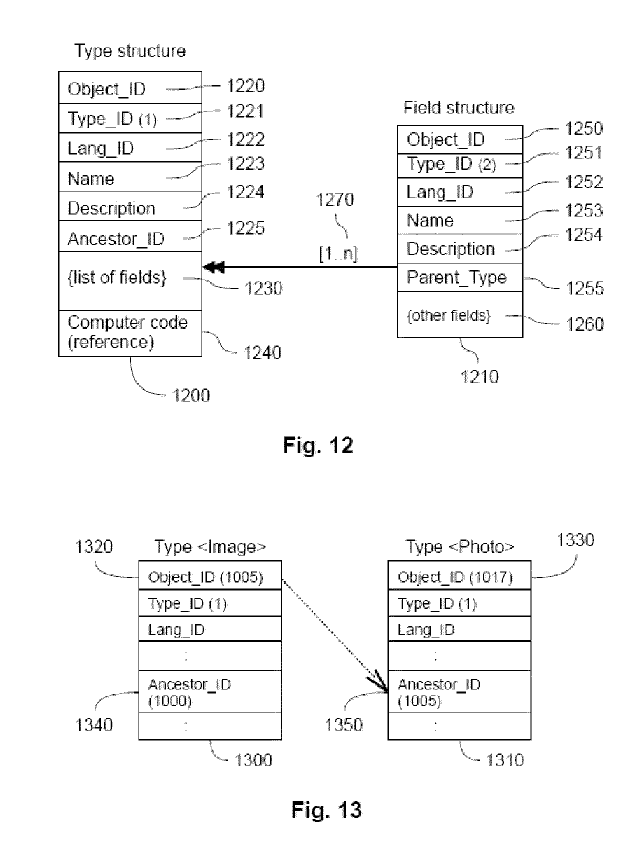

Focus-n types represent the internal structure of system and user objects of information. FIG. 12 shows the Type structure 1200, which is a particular instance of a system object, containing an Object_ID 1220 that indicates the unique identifier of the type (<1000 for system types, >1000 for user types), a Type_ID 1221 equals to 1 (the type identifier for type objects), a Lang_ID 1222 that indicates the language of the Name 1223 and Description 1224 of the type, and other fields composed by the Ancestor_ID 1225, which is the identifier of the parent type of this type (for derivation purposes), the {list of fields} 1230, that contains an array of system objects describing the fields of the type, and the Computer code (reference) 1240, which provides a means for locating the computer code of a Java class (typically, a “.jar” file) that generates the object-oriented instances for representing the user objects of information of this type (not intended for system types).

FIG. 12 also shows the Field structure 1210, which is a particular instance of a system object, containing an Object_ID 1250 that indicates the unique identifier of the field, a Type_ID 1251 equals to 2 (the type identifier for field objects), a Lang_ID 1252 that indicates the language of the Name 1253 and Description 1254 of the field, a Parent_Type 1255 for identifying the type that contains the field, and {other fields} 1260 for specifying the data attributes of the field (char, boolean, integer, string, array, object of information, etc.). Moreover, the double arrow with the label [1 . . . n] 1270 indicates that the list of fields of the type structure 1230 contains several references (at least one) to field objects.

Any Java class implementing a user object of information must provide a zero-parameters constructor and the following public methods:

result getField(fieldID);

result setField(fieldID, value);

The getField( )method returns, as the result, the value of a data or metadata field, identified by the parameter fieldID, of the user object of information. The setField( )method sets the value of a data or metadata field of the user object, according to the parameters fieldID and value, and returns as the result an error code to indicate whether that field admits the passed value and eventually the reason for rejection. With these methods, other computer code external to type classes will be able to interact with the contents of user objects.

The proposed strategies allow to manage all Focus-n types (system or user), including the type and field objects themselves. In this manner, the system for management of information is able to show the list of names and descriptions of the installed types, as well as the corresponding fields. Further, the user may command the system to incorporate new types or delete obsolete types, as well as associate software components, without the need of rebuilding the whole Focus-n application, being those types created either by the vendor of the system for management of information or by third-party developers.

### Type Derivation

New types can be derived from existing types. This mechanism allows reusing the capabilities (fields and methods) of the previous types while adding new capabilities to the new types. FIG. 13 shows an example where a new type <Photo> 1310 is derived from an existing type <Image> 1300. The existing type has an Object_ID 1320 equal to 1005 and the new type has an Object_ID 1330 equal to 1017, both above 1000 because they are types for user objects of information. The Ancestor_ID of the <Image> type 1340 is equal to 1000, which means that it is a “basic” user type, whereas the Ancestor_ID of the <Photo> type 1350 is equal to 1005, which states the type derivation.

In Practice, this example of derivation is useful since a photo is actually an image, i.e. an array of colored pixels; hence the data and metadata fields for representing an image are suitable for representing a photo. But a photo can define new data or metadata fields, such as color specs for accurate color representation or camera attributes (brand and model, objective aperture, shutter speed, focal distance, sensibility, etc.) that may not be intrinsic to other images, for example, images downloaded from the Internet. Furthermore, the software tools available for image manipulation can also be applied to photos, although the reverse situation will not be permitted.

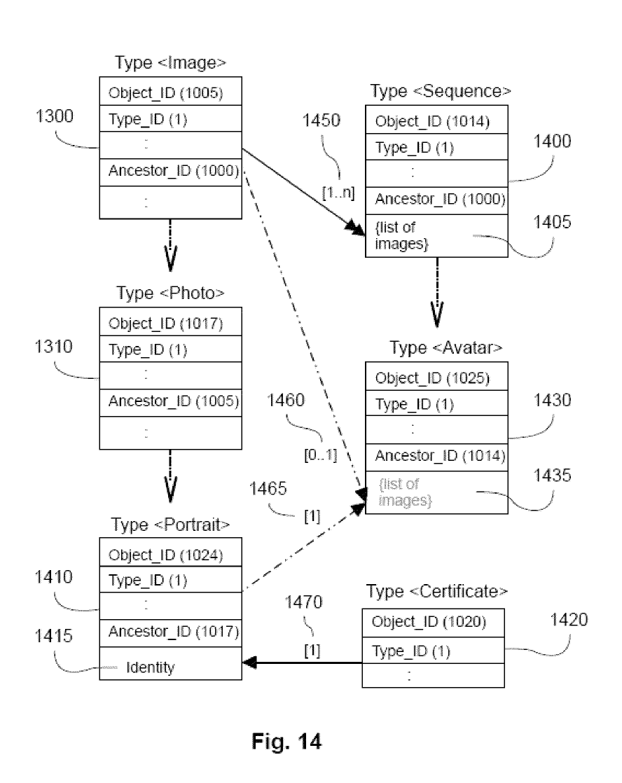

FIG. 14 is a more complex example of type derivation. The type <Sequence> 1400 describes objects of information composed of a sequence of images (i.e., an animation), being those images registered as a {list of images} 1405. This list can be implemented as an array of objects of information of type <Image> 1300, which is represented by the double arrow 1450, where the label [1 . . . n] indicates that there must be at least one image in the list.

The type <Portrait> 1410 describes objects of information that correspond to photos of people intended for formal identification, such as passport photos. Since a portrait is indeed a photo, it is derived from the type <Photo> 1310, though a portrait must include an Identity field 1415 that certifies that the person shown in the photo is actually the one that the name and description of the portrait says he or she is. This information may be an object of information of type <Certificate> 1420, that must be emitted by an authorized organization (government offices). The mandatory inclusion of such certificate is expressed by the plain arrow 1470, and the system for management of information will not permit the users to change associated certificates (or other security-related information) in any manner.

The type <Avatar> 1430 describes objects of information that iconographically represent the identity of a person, by means of one formal image and possibly another informal image. Whether there are one or two images, it can be managed as a sequence. For this reason, the type <Avatar> is derived from the type <Sequence>. However, there are some constraints on the images that can be included in the {list of images} 1435 of the type <Avatar>, which is basically a data field inherited from its ancestor type (thus the field is written in gray). These constraints are graphically expressed as the inclusion of zero to one generic (informal) image, with the dashed arrow with label [0 . . . 1] 1460, and the inclusion of strictly one formal image with the dashed arrow with label [1] 1465, being this formal image an object of information of type <Portrait>. In this manner, a user that receives an avatar from another user (within an e-mail, for example) may see the informal image first, but he or she always will be able to disclose the formal image to identify confidently the person who sent the avatar.

A final consideration is that the specific constraints for the list of images within an object of information of type <Avatar> must be verified by the corresponding setField( ) method of this type, which overrides the existing setField( )method for the type <Sequence>. Nevertheless, the overriding method may call the existing method to reuse the basic code to check the validity of the included images. For this purpose, any object of information of type <Portrait> must be considered as an object of information of type <Image>, in order to allow including a portrait in a sequence of images. To this aim, the system generalizes the type of an object to any of its ancestor types.

### Toolkits

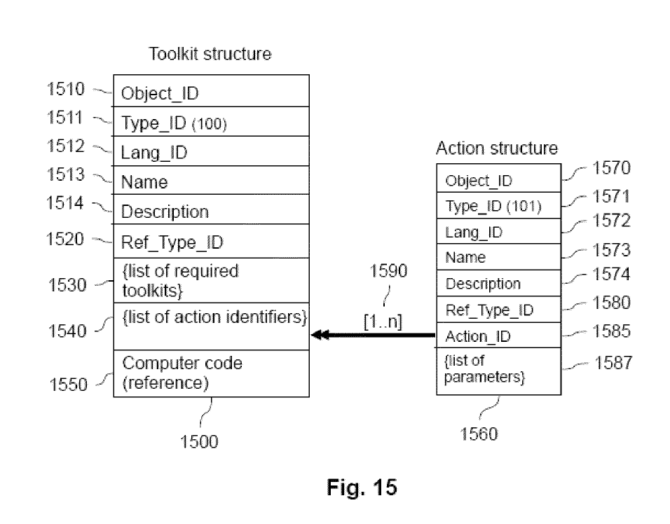

Focus-n toolkits contain groups of “actions” that can be performed on user objects of information of a specific type. FIG. 15 shows the Toolkit structure 1500, which is a particular instance of a system object, containing an Object_ID 1510 that indicates the unique identifier of the toolkit, a Type_ID 1511 equals to 100 (the type identifier for toolkit objects), a Lang_ID 1512 that indicates the language of the Name 1513 and Description 1514 of the toolkit, and other fields composed by the Ref_Type_ID 1520, which is the identifier of the type of the information to be processed by the toolkit, the {list of required toolkits} 1530, that indicates which other toolkits must be installed in the system for this toolkit to work, the {list of action identifiers} 1540, that contains an array of system objects describing the actions of the toolkit, and the Computer code (reference) 1550, which provides a means for locating the computer code of a Java class (typically, a “.jar” file) for processing the actions of the toolkit.

FIG. 15 also shows the Action structure 1560, which is a particular instance of a system object, containing an Object_ID 1570 that indicates the unique identifier of the action, a Type_ID 1571 equals to 101 (the type identifier for action objects), a Lang_ID 1572 that indicates the language of the Name 1573 and Description 1574 of the action, a Ref_Type_ID 1580 for the type identifier of the objects to be processed by the action, an Action_ID 1585 for specifying an identifier of the action relative to the type expressed in 1580, and a {list of parameters} 1587 needed for the execution of the action. Moreover, the double arrow with the label [1 . . . n] 1590 indicates that the list of action identifiers of the toolkit structure contains several references (at least one) to action objects.

Any Java class implementing a toolkit or set of actions (as a singleton) must provide a zero-parameters constructor and the following public method:

result doAction(info, actionID, params);

The doAction( )method executes the toolkit code for an action on a user object of information, according to info (the object), actionID (the action identifier), and params (the actual parameters for the action), and returns as the result an error code to indicate whether that action could be performed and eventually the reason for failure. If the execution of the action generates information that must be returned to the system, it will be done by reference on some parameters.

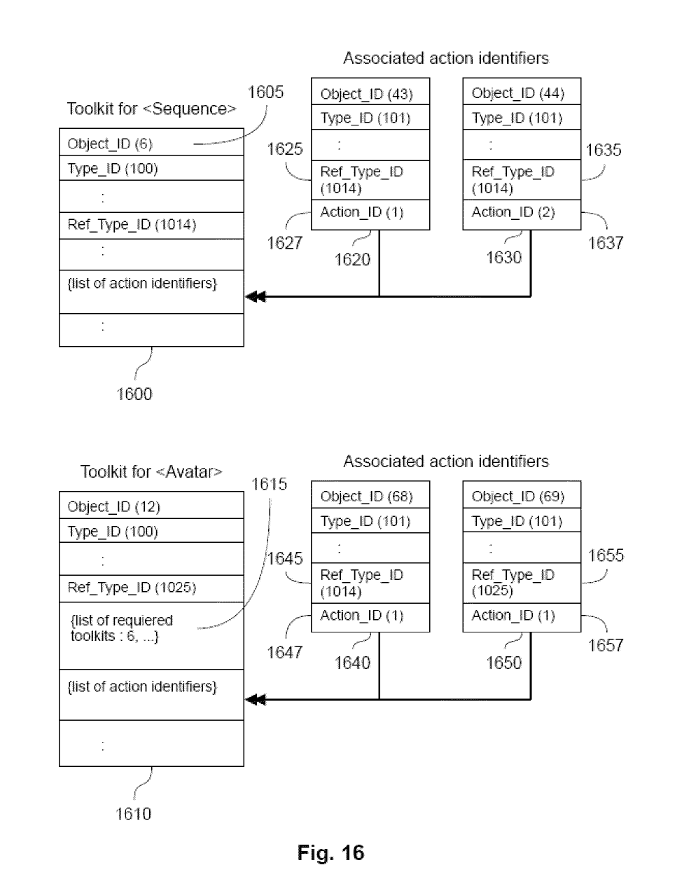

FIG. 16 shows an example of the organization of two toolkits with two actions each one, where one toolkit 1610 is for the type <Avatar>, which is derived from the type <Sequence>, associated to the other toolkit 1600 (see FIG. 14 for explanation on these types). The actions for toolkit 1600 are represented by structures 1620 and 1630, both referring to the type identifier of <Sequence> (1014) in 1625 and 1635, and with two distinct action identifiers in the domain of the type in 1627 (1) and 1637 (2). The actions for toolkit 1610 are represented by structures 1640 and 1650, but one action refers to the type identifier of <Sequence> (1014) in 1645 and the other action refers to the type identifier of <Avatar> (1025) in 1655. Hence, the action identifiers registered in 1647 and 1657 do not refer to the same type domain, thereby they do not conflict each other by having the same identifier (1). Moreover, the toolkit 1610 requires the existence of the toolkit 1600, which is expressed by including the object of information identifier in 1605 (6) in the list of required toolkits 1615. The action referred by 1640 specifies the same type and action identifiers that the action referred by 1620. This is a mechanism that allows overriding an action for an object of information of an ancestor type. For example, suppose that the work of action 1 on objects of information of type <Sequence> is to show the next image of the sequence. Obviously, this action also applies for objects of information of type <Avatar> that contain two images. But, if the image to be displayed is an object of information of type <Portrait>, some extra work should be done, for example, verifying the certificate of the portrait and displaying a marker for that verification. Therefore, the toolkit for <Avatar> must provide new code for overriding the previous action defined in the toolkit for <Sequence>. Moreover, the new action may need (at some point) to execute the code of the previous action, which is the reason for specifying that toolkit 1600 must be installed in the system for the proper working of toolkit 1610.

### Projects and Sets

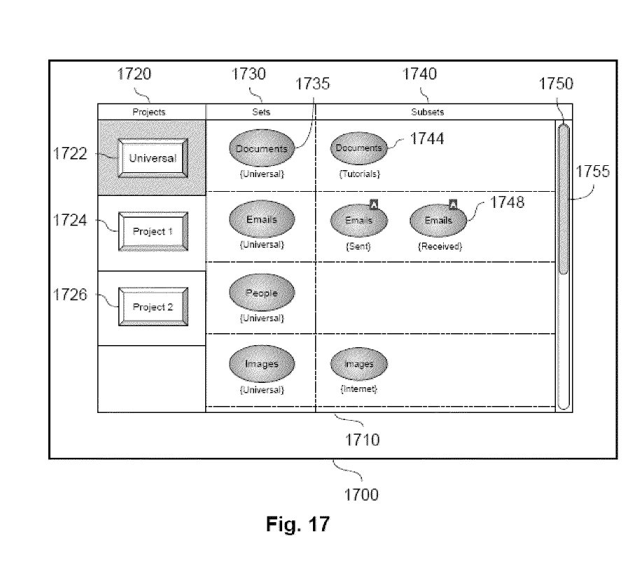

FIG. 17 shows an example of the Focus-n panel for Projects and Sets 1700, which is intended to provided a consistent access to all user objects of information. The content of the panel 1710 is enclosed within a margin. There are three columns, one for Projects 1720, another for Sets 1730 and a last one for subsets 1740.

In column 1720, each project of the user is represented as a beveled rectangle, with the name of the project inside. In the example there are three projects, [Universal] 1722, [Project 1] 1724 and [Project 2] 1726. The [Universal] project will always exist, since it is the one that automatically includes all user objects. At each moment, the user can select one and only one of the available projects, by clicking on them with the pointing device. The system for management of information highlights the selected project with a gray background; in the example, the [Universal] project is selected.

Column 1730 shows the sets associated to the selected project. There is a set for each available type, represented as an oval with the type (in plural) inside, and the name of the corresponding project down the oval in curly brackets. The system assures that each object of information belonging to a project will automatically be included in the set that corresponds to its type. For example, the {Universal} set of documents 1735 will always include all user documents.

Column 1740 shows the subsets of each set of the selected project. The user can define a number of subsets, represented as an oval with the type inside and an arbitrary name chosen by the user (in curly brackets). Subsets are aimed to group some of the objects of information contained in the corresponding set in a meaningful manner. For example, the subset {Tutorials} 1744 of documents may include the objects of information in set 1735 that are tutorials. However, since the user can include or exclude the objects of information in the subset manually, the system will not be able to guarantee that all objects of information in a subset fulfill the criteria that define the subset. To this aim, it is possible to provide means for defining automatic subsets, for which the system will automatically include or exclude objects of information according to a number of rules on object attributes. In the example, the automatic subset 1748, marked with an inverted ‘A’, will always contain all received mails. Nevertheless, the means for this method are not developed in this application.

The scrollbar 1750 allows shifting up and down the contents of columns 1730 and 1740, for when it is impossible to fit all sets and subsets into the vertical space of the panel. The scroll slider 1755 is the interface element that allows the user to control the shifting, and also indicates the relative offset and height of the viewed portion with respect to the full height of the columns. There may be another vertical scrollbar for the list of projects (not shown in the example). There will not be any horizontal scrollbar, because the system for management of information automatically adjusts the viewing scale to fit the output graphics into the available width of the panel (zoomable interface).

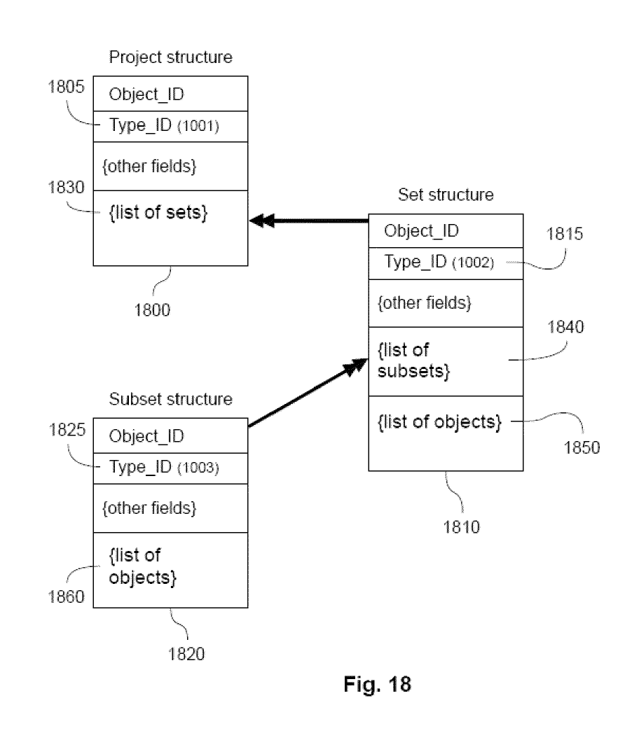

FIG. 18 illustrates the structures of projects 1800, sets 1810 and subsets 1820. All these entities are user objects of information of specific types, as Type_ID fields 1805, 1815 and 1825 contain type identifiers above 1000. A project contains a {list of sets} 1830, i.e. an array of identifiers (object locators) of the sets corresponding to that project, one set for each available type. The system for management of information will automatically create the sets for each new project. A set contains a {list of subsets} 1840, i.e. an array of identifiers (object locators) of the subsets created by the user for each set.

Moreover, each set and each subset contains a {list of objects} in fields 1850 and 1860, i.e. an array of identifiers (object locators) for all objects of information included in the set or subset. By using object locators to define a list of objects of information, the objects of information are not replicated at each insertion in a set or subset. The user will be able to add or remove objects of information in projects and subsets, which simply implies to add or remove the object locator in the corresponding list of objects. The system for management of information will control that every object of information is only included in sets or subsets of its own type. When an object of information is included in a subset, the system will also include this object in the corresponding set of the project. Finally, the system will automatically include any object of information in the corresponding set of the [Universal] project.

### Viewers

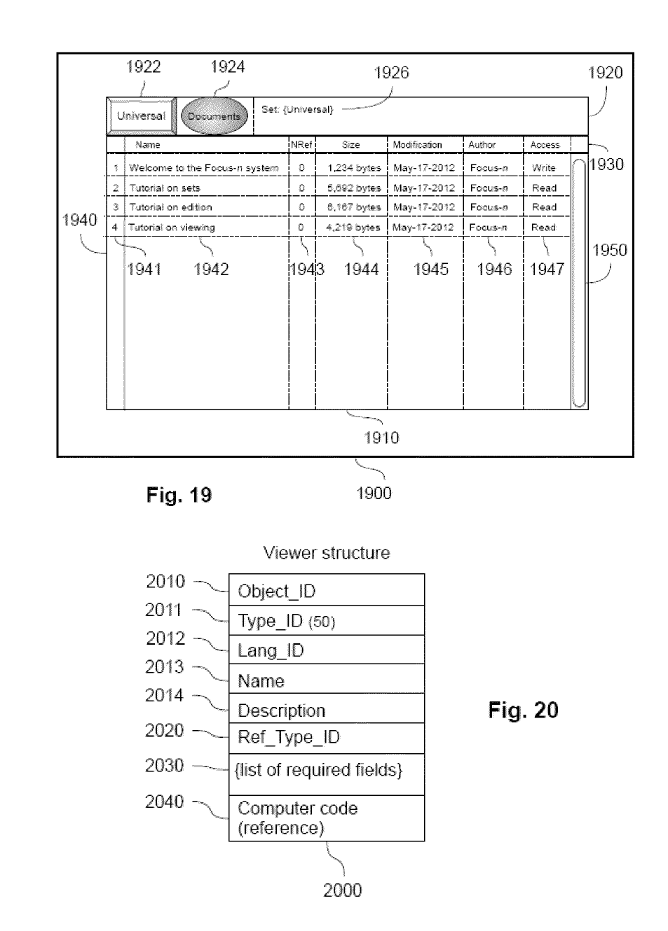

Focus-n viewers are software components that are responsible for rendering a plurality of user objects of information in a particular manner. FIG. 19 shows an example of a Focus-n panel 1900 for viewing user objects contained in a set or subset. The content of the panel 1910 is enclosed within a margin. Every viewing panel presents a Title bar 1920 for describing the set or subset that is currently viewed. The title bar always shows the selected project icon 1922, the type of the information as a set icon 1924, and the name of the selected set or subset with a text label 1926.

Beneath the title bar, each specific viewer renders the information in a particular manner. The viewer of the example shows a textual list of objects of information, with a header row 1930 specifying the meaning of the columns, and the content rows 1940, one for each object of information. In this case, the list corresponds to objects contained in the universal set of documents, and the rendered columns show a row index 1941, the name of the object of information 1942, the number of references to the object 1943 (number of insertions into other objects of information), the size in bytes 1944, the last modification date 1945, the author 1946 and the access permissions 1947 for the current user to each object. If the list is too long to fit within the viewing height, a vertical scrollbar 1950 will allow the user to access all rows. There is not a horizontal scrollbar because the system for management of information automatically adjusts the viewing scale to show all the content width (zoomable interface). Moreover, the viewer may allow the user to choose which columns are to be shown and in which order, as well as the criteria for sorting the rows.

FIG. 20 shows the Viewer structure 2000, which is a particular instance of a system object, containing an Object_ID 2010 that indicates the unique identifier of the viewer, a Type_ID 2011 equals to 50 (the type identifier for viewer objects), a Lang_ID 2012 that indicates the language of the Name 2013 and Description 2014 of the viewer, and other fields composed by the Ref_Type_ID 2020, which is the identifier of the type of the information to be processed by the viewer, the {list of required fields} 2030, that indicates which kinds of fields must have the objects to be viewed, and the Computer code (reference) 2040, which provides a means for locating the computer code of a Java class (typically, a “.jar” file) for executing the viewer processes.

When showing the content of a set or subset, the system for management of information will allow the user to choose among the available viewers that can manage the referenced type of information. This can be performed because of the field 2020, which indicates that the viewer can show the objects of information of the specified type or any type derived from that one. If the viewer is intended to show all user types, this field will be equal to 1000, since it is the identifier of the basic type for user objects of information (all other user types derive from this one). However, it may be necessary to perform a second check of the suitability of the viewer for the current type of information, which is done through the list of required fields 2030, because the viewer may need some specific data or metadata that may not be present in referenced types. For example, a viewer that exposes the objects of information in a map requires a field of global position (e.g. GPS coordinates or country/state/city/address). Thereby, it may be possible that the objects of information of the type referred in 2020 do not present this kind of information intrinsically, but the viewer is prepared to show objects of information of other derived types.

Any Java class implementing a viewer must provide a zero-parameters constructor and the following public methods:

result setArea(area);

result setSet(set);

result updateSet( )

For initiate the viewing process, the system for management of information instantiates the setArea( )method with the parameter area to indicate the available drawing area, and the setSet( )method with the parameter set to indicate which set or subset contains the objects of information to be viewed. If the content of the set changes, because one object of information is added, removed or updated, the system will instantiate the updateSet( )method, in order to make the viewer to update the drawing of the objects of information. All methods return as the result an error code to indicate whether that method could be performed and eventually the reason for failure.

### Object Content Panel

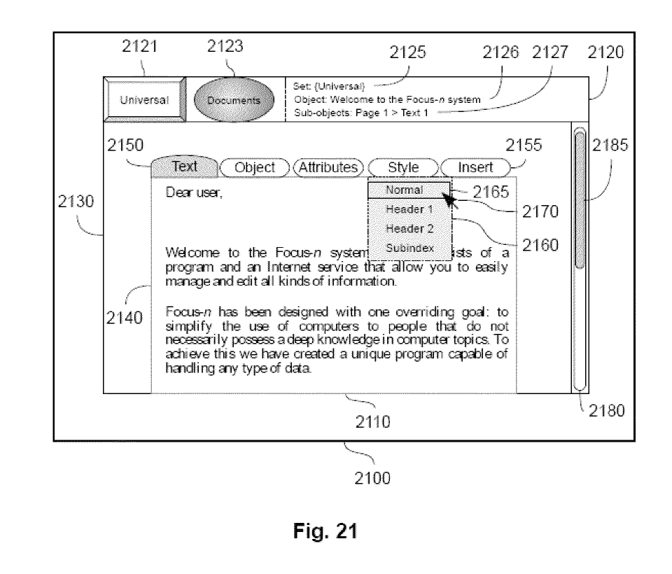

FIG. 21 shows an example of a Focus-n panel 2100 for viewing and editing the content of a user object of information. The content of the panel 2110 is enclosed within a margin. Every object content panel presents a Title bar 2120 for describing the object of information or internal object of information that is currently selected (so-said, “in focus”). The title bar always shows the selected project icon 2121, the type of the information as a set icon 2123, the name of the selected set or subset with a text label 2125, the name of the selected object 2126, and possibly the “Hierarchic Path” of the selected sub-object 2127. This path is necessary when the user selects objects of information inserted into other objects of information, which enables to view/edit those inner objects (so-called “Sub-objects”) within the context of the containing object of information. At any time, the user will also be allowed to go up in the object hierarchy.

Beneath the title bar, there is the object content area 2130. The content of the selected object of information is framed in a smaller area 2140, which makes possible to show the context of the object in the margin around, i.e. portions of the content of parent objects. Above the content of the object, the system for management of information shows a contextual interface menu. This is composed of several menus, expressed as the name of the menu enclosed in a rounded rectangle like the Insert menu 2155. The type of the information in focus is made explicit in the first rounded tag of the menu interface 2150. If the system disposes of several interface menus suitable for the type (or an ancestor type) of the selected object of information, the user will be allowed to choose among them. In any case, the interface is contextual because it is strictly related to the type or ancestor types of the object in focus. When the user clicks on a menu with the pointing device 2170, a list of actions 2160 associated to the menu appears. The system highlights the menu actions underneath the pointing device, such in 2165. Finally, the user may click on the highlighted action to trigger the related action in the corresponding toolkit.

If the content of the object of information is too high to fit within the available height, a vertical scrollbar 2180 with the corresponding scroll slider 2185 will allow the user to access all the information of the object. There is not a horizontal scrollbar because the system for management of information automatically adjusts the viewing scale to show all the content width (zoomable interface).

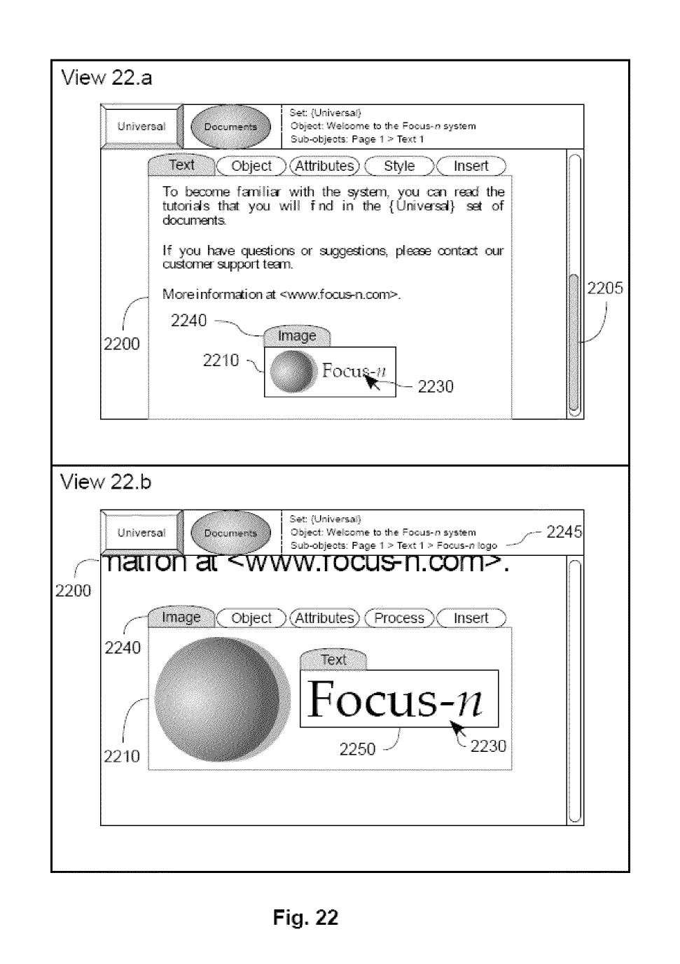

In FIG. 22, View 22.a, the text object of previous example 2200 has been shifted with the scroll slider 2205 towards its bottom and an inserted image object 2210 appeared. When moving the pointing device 2230 over the inserted object, the system for management of information highlights its enclosing frame and shows the type of the information with a rounded tag 2240. If the user clicks on it, the inserted object of information becomes the object in focus, which is represented in View 22.b of FIG. 22. The transition of the focus is shown gradually, i.e. with a zooming effect, since the system will adjust the scaling view to fit the width of the selected object 2210. Moreover, the hierarchic path will add the name of the object of information 2245, a new menu interface will appear at the right of the rounded tag with the type of the information 2240, and some content of the parent object of information 2200 may also be shown with the proper scaling in the surrounding area. In the example, the image object also contains a text sub-object 2250 that may be further selected with the pointing device 2230.

At any time, the user can click on one of the labels of the hierarchic path or the name of the object of information, and the system will zoom out the object content panel to adjust the width of the selected object. With this method, the proposed system for integrated management of information focuses the user attention on the object of information that he or she is currently viewing or editing, while working within the context of the hierarchical structure of the objects of information.

### Menu Interfaces

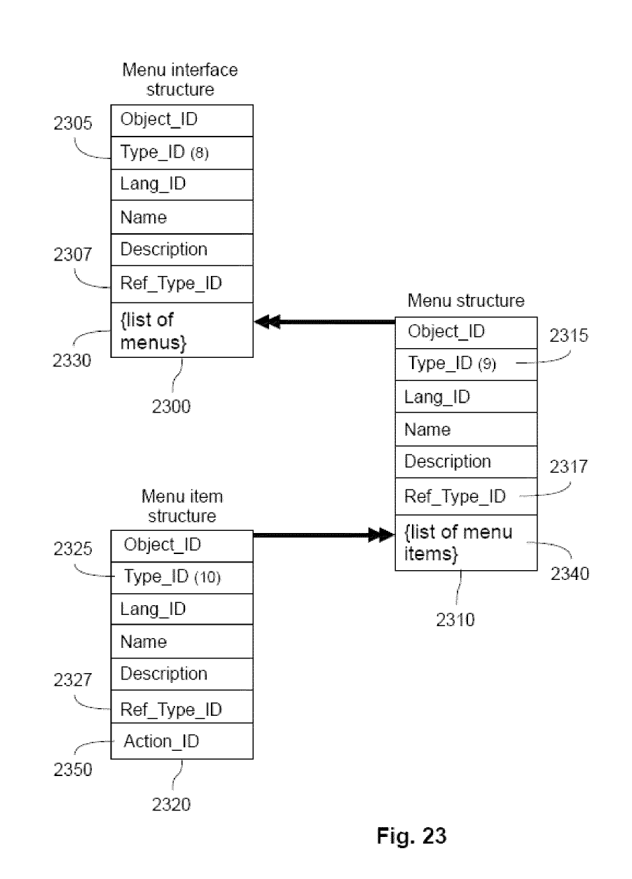

FIG. 23 shows three structures of system objects representing a “Menu interface” 2300, a “Menu” 2310 and a “Menu item” 2320. Among other fields, a menu interface object has a specific Type_ID (8) 2305, a referred type identifier Ref_Type_ID 2307 for the type of user objects to which the menu interface is concerned, and a {list of menus} 2330 that records the menus included in the interface. The menu structure contains a specific Type_ID (9) 2315, a referred type identifier 2317 and a {list of menu items} 2340 for specifying the items included in each menu. Finally, the menu item structure describes a specific Type_ID (10) 2325, a referred type identifier 2327 and an identifier of the action Action_ID 2350 associated with the menu item. When the user clicks on a menu item, the system will instantiate the referred action, that must be supported by a toolkit associated to the type of the object of information to be processed.

These structures allow the user to configure an own organization of the menu interfaces. The system for management of information will provide means for selecting one of the available menu interfaces for the object of information in focus, specifically, those menu interfaces whose Ref_Type_ID fields contain a type identifier that is the same or an ancestor of the type of the object of information. In principle, the Ref_Type_ID fields of the menus have to be equal to the Ref_Type_ID of the menu interfaces that contain those menus, and the same logic applies for the menu items contained in a menu. However, it may be convenient to use different identifiers. For example, if there are few actions programmed specifically for objects of information of type <Photo> (e.g. red-eye suppression), it may be interesting to define a menu for this type containing a menu item for each action, and include that menu in a more general menu interface for objects of information of type <Image> (see examples in the “Types” section). Obviously, the system will not activate the photo-related menu when the menu interface is activated for a generic image.

The converse situation may also apply. For example, when designing a specific menu interface for objects of information of type <Avatar>, it may be convenient to append menus or menu items for type <Sequence>, in order to manipulate the image sequence of an avatar (see examples in the “Types” section). When the user selects a menu item referencing a sequence-related action for an avatar object, the system for management of information checks the existence of such an action for sequences in a toolkit for avatar objects, which makes it possible to override the original action for sequences.

### Framers

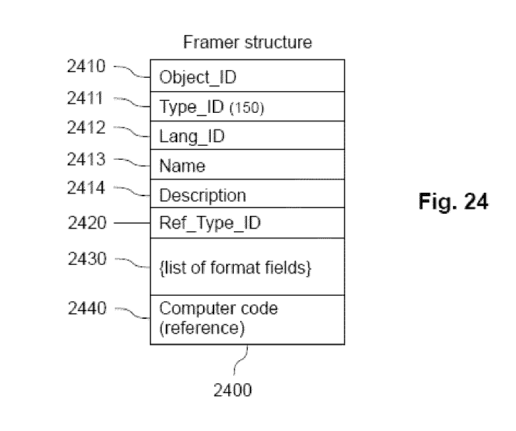

Focus-n framers are software components that are responsible for rendering the content of an object of information of a specific type within a particular frame. FIG. 24 shows the Framer structure 2400, which is a particular instance of a system object, containing an Object_ID 2410 that indicates the unique identifier of the framer, a Type_ID 2411 equals to 150 (the type identifier for framer objects), a Lang_ID 2412 that indicates the language of the Name 2413 and Description 2414 of the framer, and other fields composed by the Ref_Type_ID 2420, which is the identifier of the type of the information to be processed by the framer, the {list of format fields} 2430, that indicates which kinds of fields for formatting attributes must have the correspondent frames, and the Computer code (reference) 2440, which provides a means for locating the computer code of a Java class (typically, a “.jar” file) for executing the framer processes.

In the “Hierarchic Frames” section, FIG. 6 shows the structure of a hierarchic frame, which enables the system for management of information to represent the hierarchical structure of user objects of information. The Framer_ID 610 of each hierarchic frame must be equal to the Object_ID 2410 of the framer that will control that frame. Hence, the object identifier of the framer acts as a “frame type”. Since third-party developers will have to program the framers for their particular types; there must be a central organization that assigns the object identifiers for framers in order to avoid numbering conflicts.

Besides, this approach opens the possibility to define different framers for the same type of information. Actually, this possibility is useful for allowing different formatting and layout information for the same type of information. For example, there may be a text framer that provides typical formatting features, like font type, size and style, and typical layout features, like left-to-right word alignment in top-to-down horizontal lines, whereas there may be other text framers that provide specific formatting and layout features for special character combinations and ligatures, or for artistic word effects. Therefore, each frame will record the formatting and layout information needed by its framer. If the user changes the framer of a frame, the previous formatting information may be discarded and the user may be required to supply new formatting information.

Any Java class implementing a framer must provide a zero-parameters constructor and the following public methods:

result setOuterBounds(mode, bounds);

void innerShapeUpdated(mode);

Focus-n frames are defined by rectangular outer bounds but also by an arbitrary inner shape inscribed in the outer bounds. This inner shape provides a means of modifying the internal layout of the object of information. For example, a framer for text objects may fit the text within several columns, or a framer for image objects may fit or clip the pixels into non-rectangular shapes.

The setOuterBounds( )method will be instantiated when the user changes the area of the frame, specifying the new area in the parameter bounds. Another possibility is that the user changes the area of a parent frame, and the parent framer stretches or expands the inner frames proportionally, so it will call setOuterBounds( ) for its inner frames and, recursively, this call may provoke other calls into deeper levels of the object hierarchy. The mode parameter is intended to distinguish between different calling situations (user command or parent invocation). The method returns as the result an error code to indicate whether the bounds could be changed and eventually the reason for failure.

In the other hand, the framers will provide means for the user to change the inner shape of a frame, but this may provoke a change in the size of the frame. For example, stretching the width of a text column may make the text flow to require extra lines, thereby enlarging the frame height. If this text object is inserted into another object of information, the available area within the parent frame may be reduced. Indeed, the shape of a frame can delimit the inner shape of parent or sibling frames. For this reason, any change in the position or shape of a frame must be communicated to the parent frames and also to other inner frames by instantiating their innerShapeUpdated( )method, so that the corresponding framers can adjust their content accordingly. The parameter mode can be used to distinguish between different types of calls (from inner frame, from parent frame), which will be necessary to avoid infinite recurrent calls in the traversal of the frame hierarchy. This method does not return anything because is intended for notification purposes, so the successive processing will be performed in any case.

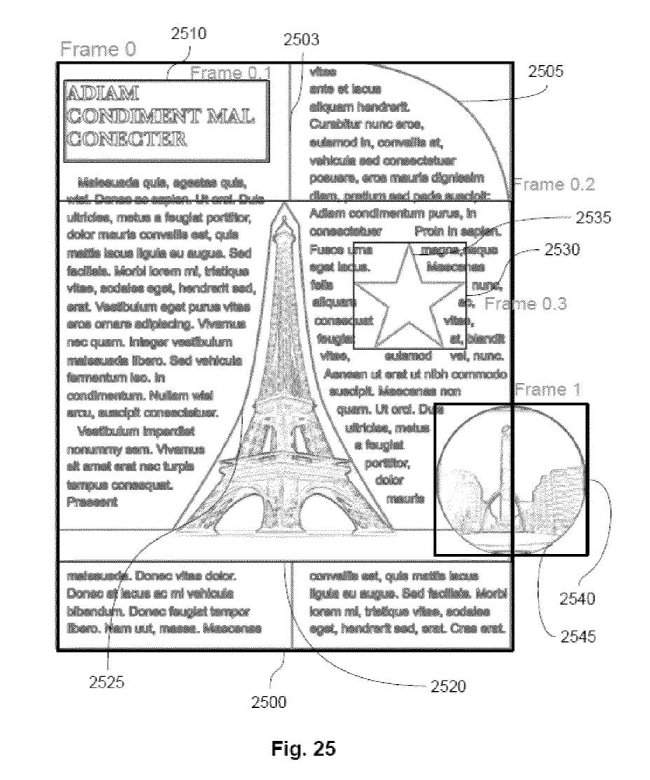

FIG. 25 is an example of interactions between outer bounds and inner shapes in a specific object hierarchy. There are two main frames, named as “Frame 0” 2500 and “Frame 1” 2540, which are supposed to be siblings within another top frame that is not shown. Moreover, “frame 0” contain three internal frames, “Frame 0.1” 2510, “Frame 0.2” 2520 and “Frame 0.3” 2530. Frames 0 and 0.1 contain text, frames 1 and 0.2 contain images and frame 0.3 contains a drawing. Except for frame 0.1, the rest of frames present differences between their rectangular bounds (in black) and their inner shape (in gray). In frame 1, for example, the inner shape is an oval 2545 that clips the image content. The inner shape of frame 0.3 is the perimeter of the drawing (i.e. a star) 2535. In frame 0.2, the user adjusted the inner shape to follow the margins of the main topic of the image (i.e. the Eiffel tower) 2525. Finally, the text of frame 0 is delimited by the double column form 2503 and the rounded limit in the top-right corner 2505, as well as by the inner shapes of the other frames.

Therefore, the framer of “frame 0” determines the layout of the text according to the resultant inner shape. Any change in position or inner shape of the internal frames or the sibling frame must result in a call to method innerShapeUpdated( ) of framer of frame 0, in order to update the layout of text. On the contrary, a change in the inner shape of frame 0 will not notify the internal frames or sibling frame, because the inner shape delimitation is an unidirectional relationship between frames, that must be stated by the user.

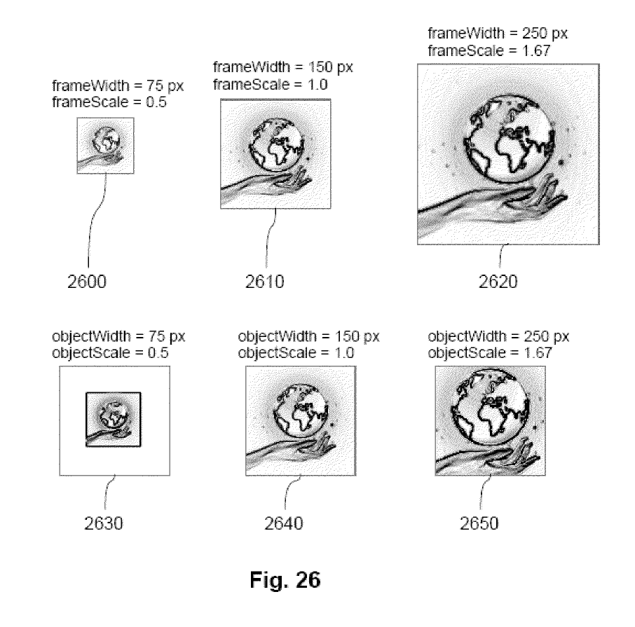

FIG. 26 shows several examples of frame scaling and object scaling. Frame scaling occurs when the user sets a frame width that differs from the original width of the object of information, which needs a specific scaling factor, named as “frameScale”, to adjust the visualization of the object of information. The image in the example is 150 pixels width. The frame widths in 2600, 2610 and 2620 are smaller, equal and bigger that the image width, which results in specific frame scaling factors 0.5, 1.0 and 1.67, respectively.

Object scaling occurs when the user needs to make the object of information smaller or bigger than the frame space, which needs another specific scaling factor, named as “objectScale”. The object widths in 2630, 2640 and 2650 are smaller, equal and bigger than the frame width, which results in the corresponding object scaling factors and, eventually, the margining (objectScale <1.0) or the clipping (objectScale >1.0) of the object content, as in 2630 and 2650.

The final scaling of the object content will be the product of the two scaling factors. Moreover, since the whole working environment is zoomable, the system for management of information multiplies a third scaling factor (named as “viewScale”) to render the objects of information within the screen or graphics window.

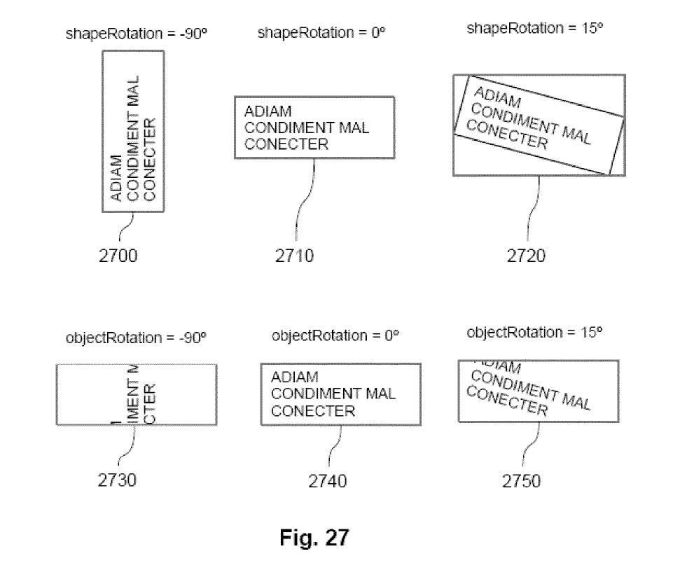

FIG. 27 show several examples of shape rotation and object rotation. Shape rotation occurs when the user rotates the inner shape of a frame by a certain amount of degrees, which needs a specific rotation factor, named as “shapeRotation”. The shape rotations in 2700, 2710 and 2720 are −90°, 0° and 15°, respectively. The object of information content will be rotated as well, because the scaling and rotation factors apply to the rendering of the whole content of the frame. Moreover, the system will adjust the outer bounds of the frame to box the rotated inner shapes.

Object rotation occurs when the user needs to rotate the object content with independence of the orientation of the inner shape, which needs another specific rotation factor, named as “objectRotation”. The object of information rotations in 2730, 2740 and 2750 are −90°, 0° and 15°, respectively. In this case, the frame shape will not be adapted, so the content of the object of information may be clipped as in 2730 and 2750. The final rotation of the object content will be the sum of the two rotation factors.

The system and method for management of information disclosed herein are intended to arrange the computer information (data and code) in a more efficient manner than current systems. However, other variations and modifications of the invention will be apparent to those skilled in the art. Moreover, the possible types and presentations of data objects are not limited to the ones provided in the recited examples. Therefore, it is the object of the appended claims to cover all possible variations of structures and methods, as well as all possible implementations of different types of information, as they come within the true spirit and scope of the invention.

What is claimed is:

1. A system for integrated management of end-user information, being that system, comprising a unique computer application and a single object-oriented database, where said unique computer application and a software manager for said database are stored and executed on a computer device, said unique computer application providing means for creating and editing objects of information of different types, said type of information including at least text, images, tables, graphics, formulas, sounds, videos, said objects of information of different types being organized into hierarchical structures providing high-level structured documents such as reports, books, e-mails, presentations, web pages, blogs, and being all of said high-level structured documents recorded into said single object-oriented database,
wherein said objects of information of different types are identified by a type identifier and an object identifier, the type identifier being a unique number for each type of information, and the object identifier being a unique number within a specific range of each type of information,
wherein each type of information is described in terms of data fields and metadata fields, where said data fields register the intrinsic content of the object of information and said metadata fields register some attributes about the data content including language, name and description of the objects of information, and
wherein said unique computer application is a compound of a plurality of software components that can be included in or excluded from the application to provide specific functionality for implementing management of specific high-level structured documents.

2. The system according to claim 1, wherein said objects of information of different types included inserted one or a plurality of any other objects of information of any type, being the inserted one or a plurality of any other objects of information not necessarily replicated but referenced from the parent object through an object locator.

3. The system according to claim 1, further comprising means for managing menu interfaces executed on said device computer, said menu interfaces being composed of a plurality of menus which are in turn composed of a plurality of menu items, implying the management of specific high-level structured documents, said menu interfaces, said plurality of menus and said plurality of menu items being associated with a specific type of information for which the actions of a specific toolkit or set of actions can be applied by means of an action reference included in each menu item.

4. The system according to claim 3, further comprising means for allowing a user to select among a plurality of menu interfaces for a given type of information to be edited, according to the type of information and the type for which the menu interfaces apply including the menu interfaces that apply to ancestor types of information.

5. A method for integrated management of end-user information, using a unique computer application and a single object-oriented database, where said unique computer application and a software manager for said database are stored and executed on a computer device, wherein said method comprising using said computer device for:
creating and editing objects of information of different types, said type of information including text, images, tables, graphics, formulas, sounds, videos, providing high-level structured documents by organizing them into hierarchical structures;
recording all of said high-level structured documents into said single object-oriented database; and
importing new types of information or deleting existing types of information implying management of specific types of information for describing the type of information itself and the related data and metadata fields,
wherein said objects of information of different types are identified by a type identifier and an object identifier, the type identifier being a unique number for each type of information, and the object identifier being a unique number within a specific range of each type of information,
wherein each type of information is described in terms of data fields and metadata fields, where said data fields register the intrinsic content of the object of information and said metadata fields register some attributes about the data content including language, name and description of the objects of information, and
wherein said unique computer application is a compound of a plurality of software components that can be included in or excluded from the application to provide specific functionality for implementing management of specific high-level structured documents.

6. A method according to claim 5, wherein further comprising specifying new types of information derived from existing types, which implies reuse of fields defined in an ancestor type of information, as well as functionality of related software components.

7. A method according to claim 5, further comprising specifying new types of information derived from existing types by reuse of fields defined in an ancestor type of information, as well as functionality of related software components and managing by said computer device toolkits of actions to be performed on specific types of information, and allowing a user to import new toolkits or actions, or delete existing toolkits or actions, which implies management of specific types of information for describing the toolkits and actions and software components for executing the actions.

8. A method according to claim 5 further comprising specifying new types of information derived from existing types by reuse of fields defined in an ancestor type of information and executing actions defined for an ancestor type of information onto objects of a derived type of information, for overriding existing actions defined for ancestor types of information and for invoking actions of an ancestor type of information from within an action defined for a derived type of information.

9. A method according to claim 5, wherein said hierarchical structures are managed by means of internal hierarchic frames handling formatting and layout of content of one object in a manner independent of processing of the objects of information by corresponding actions, being the formatting and layout procedures included in special software components of said unique computer application, termed framers, and allowing the user to import new framers, or delete existing framers.

10. A method according to claim 5 wherein said hierarchical structures are managed by means of internal hierarchic frames handling the formatting and layout of the content of one object in a manner independent of the processing of the objects of information by the corresponding actions, being the formatting and layout procedures included in special software components of said unique computer application, termed framers, and allowing the user to import new framers, or delete existing framers and further comprising positioning the internal frames within a parent frame, so that a corresponding framer of the said parent frame can position the internal frames according to geometrical relations between the said internal frames, and for synchronizing the position and formatting of internal frames of the said parent frame inserted in other frames.

11. A method according to claim 10, wherein further comprising fitting content of the object enclosed by a frame into an inner shape of at least an area smaller than an outer rectangular bounds of said frame, said inner shape being delimited by other inner shapes of internal frames or sibling frames of said frame, and scaling and rotating the inner shape or the object content itself.

12. A method according to claim 5, wherein comprising further organizing user objects of information of different types in heterogeneous groups called projects and user objects of information of the same type in homogeneous groups called sets and subsets, where each one of said projects contains a unique set for each type of information, and the objects of same type in each set are organized into a plurality of subsets.

13. A method according to claim 5, wherein further comprising managing different linguistic versions of same object of information of any type, including a language identifier for each version and a plurality of specific descriptors for each version, included in a locator of the object, said versions forming a group called Babel bubble, and enabling the user to change between the representation of the object of information by choosing among the available languages, and to add new linguistic versions to, or delete existing versions from said group of linguistic versions.

14. A method according to claim 5, comprising further organizing user objects of information of different types in heterogeneous groups called projects and user objects of information of the same type in homogeneous groups called sets and subsets, where each one of said projects contains a unique set for each type of information and the objects of the same type in each set are organized into a plurality of subsets and further comprising viewing a list of objects of information included in said set or subset and allowing the user to import new viewers or delete existing viewers.

15. A method according to claim 5, comprising further organizing user objects of information of different types in heterogeneous groups called projects and user objects of information of the same type in homogeneous groups called sets and subsets, where each one of said projects contains a unique set for each type of information, and the objects of the same type in each set are organized into a plurality of subsets and further comprising viewing a list of objects of information included in said set or subset and allowing the user to import new viewers or delete existing viewers, wherein further comprising selecting among a plurality of viewers for a given set or subset to be listed according to the type and fields of the information of said set or subset and the type and fields that the available viewers require including the viewers designed for ancestor types of the information to be shown.
